(19) United States
(12) Patent Application Publication
(10) Pub. No.: US 2007/0247640 A1
(43) Pub. Date: Oct. 25, 2007

(54) Exposure Apparatus, Exposure Method and Device Manufacturing Method, and Surface Shape Detection Unit

(75) Inventors: Nobutaka Magome, Kumagaya-shi (JP); Hideo Mizutani, Yokohama-shi (JP); Yasuhiro Hidaka, Kumagaya-shi (JP)

Correspondence Address: OLIFF & BERRIDGE, PLC, P.O. BOX 19928, ALEXANDRIA, VA, 22320, US

(73) Assignee: Nikon Corporation, Tokyo (JP)

(21) Appl. No.: 10/594,509

(22) PCT Filed: Mar. 30, 2005
(86) PCT No.: PCT/JP05/06071

§ 371 Date: Sep. 28, 2006

(30) Foreign Application Priority Data
Mar. 30, 2004 (JP) 2004-099530

(51) Int. Cl. G01B 11/30

(52) U.S. Cl. 356/609; 356/601

(57) ABSTRACT

In subroutine 201 and step 205, a best image-forming plane of a projection optical system and an offset component of a multipoint AF system are detected as calibration information. During measurement of a wafer alignment mark by an alignment system in step 215, the multipoint AF system detects information related to a surface shape of a surface subject to exposure of a wafer (Z map). In step 219, a Z position order profile regarding position order (Z, θx, θy) related to autofocus leveling control is made, along with an XY position order profile of a wafer stage during scanning exposure, and in step 221, scanning exposure is performed while performing open control based on the position order.

### TECHNICAL FIELD

The present invention relates to exposure apparatuses, exposure methods, device manufacturing methods, and surface shape detection units, and more particularly to an exposure apparatus and an exposure method in which on object is exposed via a projection optical system, a device manufacturing method that uses the exposure apparatus or the exposure method, and a surface shape detection unit that detects information related to a surface shape of a surface subject to exposure of the object.

### BACKGROUND ART

Conventionally, in a lithographic process for manufacturing electronic devices such as semiconductor devices (integrated circuits) and liquid-crystal display devices, a projection exposure apparatus that transfers an image of a pattern on a mask or reticle (hereinafter generally referred to as a ‘reticle’) onto each shot area on a photosensitive substrate such as a wafer coated with resist (photosensitive agent) or on a glass plate (hereinafter referred to as a ‘substrate’ or ‘wafer’) via a projection optical system has been used. As this type of projection exposure apparatus, conventionally, the reduction projection exposure apparatus by the step-and-repeat method (the so-called stepper) has been mainly used, however, in recent years, the projection exposure apparatus by the step-and-scan method (the so-called scanning stepper) that performs exposure while synchronously scanning a reticle and a wafer is gathering attention.

When performing exposure using this type of exposure apparatus, in order to suppress generation of exposure defect due to defocus as much as possible, the so-called autofocus leveling control is performed in which a position of a substrate in an optical axis direction of a projection optical system is detected by a focal point position detection system (a focus detection system), and based on the detection results, an exposure area (an area to which an exposure light is illuminated) on the substrate is positioned within a range of depth of focus of the best image-forming plane of the projection optical system. Normally, as such a focal point position detection system, a multiple focal point position detection system based on an oblique method (hereinafter referred to as a ‘multipoint AF system’) is employed (for example, refer to Patent Documents 1 and 2, and the like).

However, in the projection exposure apparatus stated above, the larger the numerical aperture (NA) of the projection optical system is, the more the resolution improves, and therefore, recently, the diameter of a lens used in the projection optical system, in particular, the diameter of the lens constituting the projection optical system closest to an image plane side is getting larger. According to the larger diameter of the lens, a distance between the lens and the substrate (the so-called working distance) becomes smaller, which makes it difficult as a consequence to arrange the multipoint AF system.

Patent Document 1: Kokai (Japanese Unexamined Patent Application Publication) No. 06-283403, and

Patent Document 2: the U.S. Pat. No. 5,448,332.

### DISCLOSURE OF INVENTION

Means for Solving the Problems

The present invention has been made in consideration of the situation described above, and according to a first aspect of the present invention, there is provided an exposure apparatus that performs exposure to an object via a projection optical system, the apparatus comprising: a stage that is movable in at least directions of three degrees of freedom that include an optical axis direction of the projection optical system and two-dimensional directions within a plane orthogonal to the optical axis while holding the object, and can adjust a position of the object in the optical axis direction; a first position detection unit that detects position information of the stage in the optical axis direction; a second position detection unit that detects position information of the stage within the plane orthogonal to the optical axis; a surface shape detection system that detects information related to a surface shape of a surface subject to exposure of the object held on the stage, prior to the exposure; and an adjustment unit that adjusts a surface position of the surface subject to exposure of the object by driving the stage based on the detection results of the surface shape detection system and the detection results of the first and second position detection units, when performing exposure to the object.

With this apparatus, prior to exposure, the surface shape detection system detects the information related to a surface shape of the surface subject to exposure on the object held on the stage, and when performing exposure to the object, the adjustment unit adjust a surface position of the object on the stage based on the information related to a surface shape of the surface subject to exposure detected by the surface shape detection system (the detection results of the surface shape detection system) and the detection results of the first and second position detection units. Accordingly, on exposure, without detecting the position of the object in the optical axis direction of the projection optical system by the focal point position detection system, an exposure area (an area to which an exposure light is illuminated) on the object during the exposure can be positioned within a range of depth of focus of the best image-forming plane of the projection optical system.

According to a second aspect of the present invention, there is provided an exposure method in which exposure is performed to an object via a projection optical system, the method comprising: a detection process in which information related a datum position of the object in an optical axis direction of the projection optical system is detected, along with information related to a surface shape of a surface subject to exposure of the object in the optical axis direction, prior to exposure; and an exposure process in which exposure is performed while adjusting a surface position of the surface subject to exposure of the object based on the detection results.

With this method, prior to exposure, the information related to a datum position of the object in the optical axis direction of the projection optical system is detected, along with the information related to a surface shape of the surface subject to exposure of the object in the optical axis direction, and on exposure, a surface position of the object on the stage is adjusted based on the information related to a surface shape of the surface subject to exposure and the information related to a datum position of the object in the optical axis direction. Accordingly, an exposure area (an area to which an exposure light is illuminated) on the object during the exposure can be positioned within a range of depth of focus of the best image-forming plane of the projection optical system without detecting the position of the object in the optical axis direction of the projection optical system by the focal point position detection system.

According to a third aspect of the present invention, there is provided a surface shape detection unit, comprising: a stage that can hold an object and is movable in a predetermined direction; an irradiation system that irradiates an illumination light to a strip-shaped area that the object held on the stage crosses by movement of the stage; a photodetection system that receives a reflected light of the illumination light from a surface subject to exposure of the object when the object crosses the strip-shaped area; a detection unit that detects information related to a surface shape of the surface subject to exposure of the object, based on a position deviation amount from a datum position of a photodetection position of the reflected light in the photodetection system.

With this unit, by photodetecting the reflected light generated by the irradiation light irradiated to the strip-shaped area that the object crosses during movement being reflected off an object surface, a surface shape of the object can be detected in a non-contact manner based a position deviation amount from a datum position of the photodetection position.

Further, according to a fourth aspect of the present invention, there is provided an exposure apparatus, comprising: a stage that can hold an object subject to exposure and is movable in a predetermined direction; a detection unit that has an irradiation system to irradiate an illumination light to a strip-shaped area that the object held on the stage crosses by movement of the stage and a photodetection system to receive a reflected light of the illumination light from a surface subject to exposure of the object when the object crosses the strip-shaped area, and detects information related to a surface shape of the surface subject to exposure of the object based on output of the photodetection system; and a controller that controls the stage so that the object crosses the strip-shaped area, and performs surface position adjustment of the surface subject to exposure of the object based on information of a surface shape of a substantially entire area of the surface subject to exposure of the object, the information being obtained by the object crossing the strip-shaped area once.

With this apparatus, the information of a surface shape of a substantially entire area of the surface subject to exposure of the object can be obtained in a short period of time.

Further, in a lithography process, by transferring a device pattern onto an object using the exposure apparatus of the present invention, microdevices of higher-integration can be manufactured with good productivity. Accordingly, it can also be said from another aspect that the present invention is a device manufacturing method that includes a lithography process using the exposure apparatus of the present invention. Likewise, in a lithography process, by transferring a device pattern onto an object using the exposure method of the present invention, microdevices of higher-integration can be manufactured with good productivity. Accordingly, it can also be said further from another aspect that the present invention is a device manufacturing method that includes a lithography process using the exposure method of the present invention.

### BRIEF DESCRIPTION OF THE DRAWINGS

In the accompanying drawings;

FIG. 1 is a view schematically showing a configuration of an exposure apparatus related to an embodiment of the present invention;

FIG. 2 is a perspective view showing a wafer stage;

FIG. 3 is a view showing a state when an aerial image of a measurement mark on a reticle is measured using an aerial image measurement unit;

FIG. 4 is a view showing a state when a surface shape of a surface subject to exposure of a wafer is measured using a multipoint AF system;

FIG. 5 is a view showing a positional relation between an arrangement of slit images serving as measurement points of the multipoint AF system and a measurement area;

FIG. 6 is an enlarged view showing one of RA detection systems, a RA detection system 12A and its vicinity in FIG. 1;

FIG. 7 is a block diagram showing a main configuration of a control system of the exposure apparatus in FIG. 1;

FIG. 8A is a view showing a coordinate system that has a best focus position on an optical axis of a projection optical system as an origin and a coordinate system that has a center of the measurement area of the multipoint AF system as an origin;

FIG. 8B is a view showing measurement points of the best focus position in an exposure area;

FIG. 8C is a view showing an example of an offset component at each measurement point in the multipoint AF system;

FIG. 9 is a flowchart showing a processing algorithm of a main controller on exposure operations in the exposure apparatus of the embodiment of the present invention;

FIG. 10 is a flowchart showing processing procedures of a subroutine of detection of the best focus position of the projection optical system;

FIG. 11A is a top view showing an example of a wafer W subject to exposure;

FIG. 11B is a view showing an example of a continuous value function that denotes a surface shape of wafer W obtained from a Z map related to a cross section taken along the line A-A′ of wafer W in FIG. 11A;

FIG. 12A is a perspective view showing an example of a configuration of another surface shape detection unit;

FIG. 12B is a top view showing the surface shape detection unit and its vicinity in FIG. 12A;

FIG. 12C is an enlarged view showing an irradiation area SL;

FIG. 13 is a view showing a schematic configuration of an interferometer system used to detect a surface shape of the surface subject to exposure of the wafer;

FIG. 14 is a flowchart used to explain an embodiment of a device manufacturing method related to the present invention; and

FIG. 15 is a flowchart showing details of step 804 in FIG. 14.

### BEST MODE FOR CARRYING OUT THE INVENTION

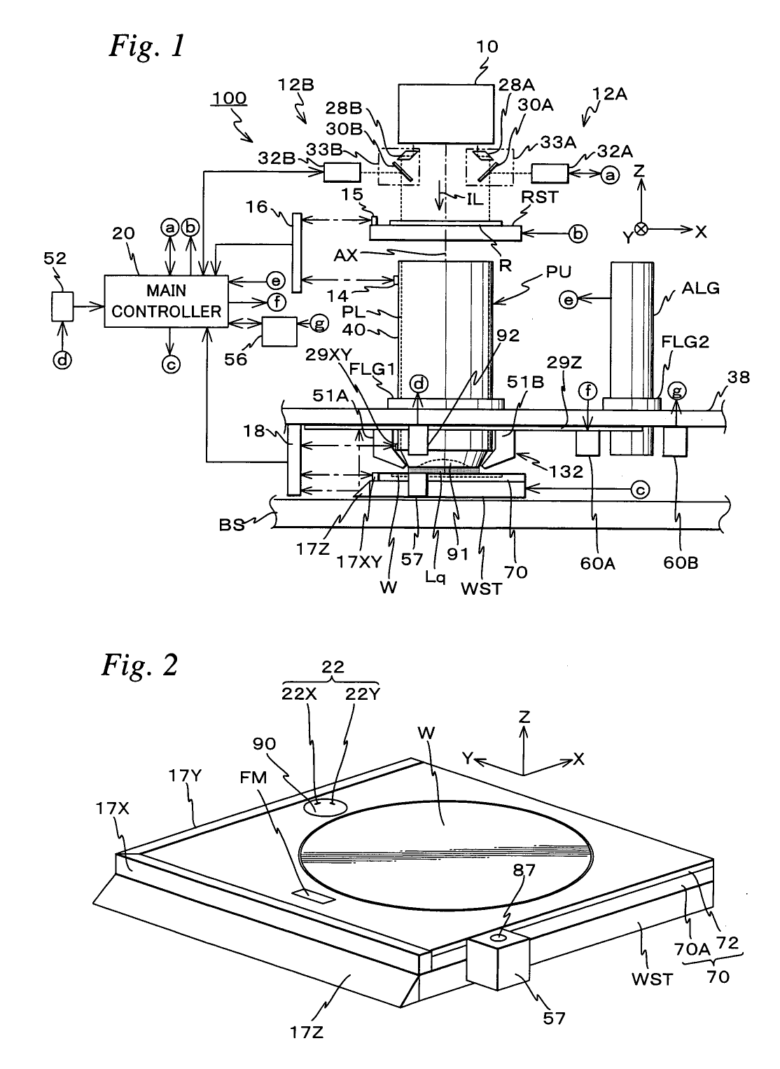

An embodiment of the present invention will be described based on FIG. 1 to FIG. 11B. FIG. 1 shows the schematic configuration of an exposure apparatus 100 related to an embodiment of the present invention. Exposure apparatus 100 is a projection exposure apparatus by the step-and-scan method (a scanning stepper (also called as a scanner)).

Exposure apparatus 100 is equipped with an illumination system 10 that includes a light source and illumination optical system (such as a movable reticle blind to be described later) and an illuminates a reticle R with an illumination light (an exposure light) IL as an energy beam, a reticle stage RST holding a reticle R, a projection unit PU, a wafer stage WST where a wafer W is mounted, a body (a part of which is shown in FIG. 1) where reticle stage RST, projection unit PU and the like are mounted, a control system having overall control over the entire apparatus, and the like.

Illumination system 10 is, for example as disclosed in Kokai (Japanese Unexamined Patent Application Publication) No. 2001-313250 and the corresponding U.S. Patent Application Publication No. US 2003/0025890 and the like, configured containing a light source, an illuminance uniformity optical system including an optical integrator, an illumination system aperture stop, abeam splitter, a relay lens, a variable ND filter, a reticle blind (a fixed reticle blind and a movable reticle blind) and the like (none of which are shown). Under the control of a main controller 20, illumination system 10 illuminates illumination light IL with almost uniform illuminance to a slit-shaped illumination area (an area set by the reticle blind) which longitudinal extends in an X-axis direction (a lateral direction of the page surface in FIG. 1) on reticle R on which a circuit pattern and the like is drawn. In this case, as illumination light IL, an ArF excimer laser (wavelength: 193 nm) is used as an example. Further, as the optical integrator, a fly-eye lens, a rod integrator (an internal reflection type integrator), a diffractive optical element, or the like can be used. Illumination system 10 may have the configuration similar to the illumination system as disclosed in, for example, Kokai (Japanese Unexamined Patent Application Publication) No. 06-349701 and the corresponding U.S. Pat. No. 5,534,970, and the like. As long as the national laws in designated states (or elected states), to which this international application is applied, permit, the above disclosures of the publications and the corresponding U.S. Patent Application Publication or U.S. Patent are incorporated herein by reference.

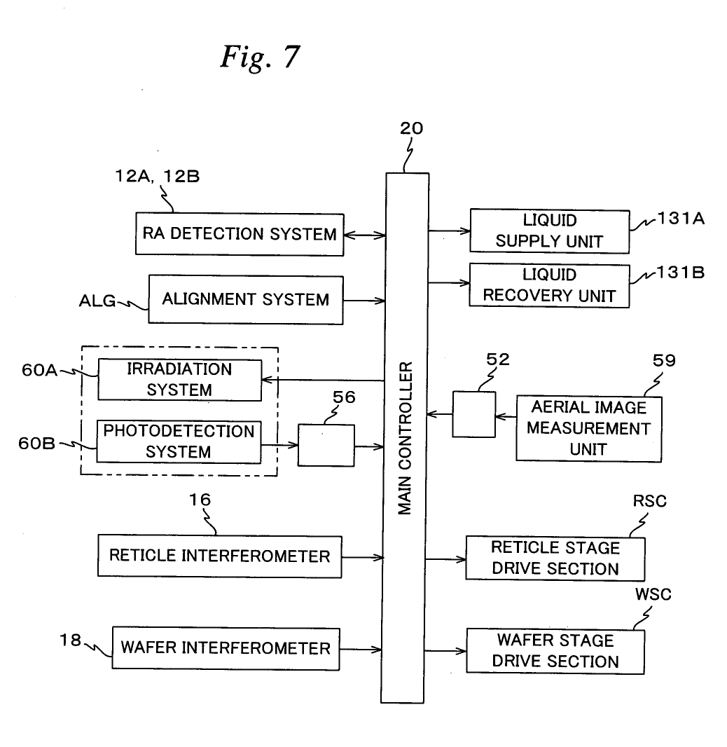

Reticle stage RST is supported by levitation, for example, via a clearance of around several μm above a reticle base (not shown) by an air bearing or the like (not shown) that is arranged on the bottom surface of reticle stage RST. On reticle stage RST, reticle R is fixed by, for example, vacuum suction (or electrostatic suction). Reticle stage RST has a structure finely drivable two-dimensionally within an XY plane (the X-axis direction, a Y-axis direction and a rotation direction around a Z-axis direction orthogonal to the XY plane (a θz direction)) perpendicular to an optical axis AX of projection optical system PL, which will be described later, by a reticle stage drive section RSC (not shown in FIG. 1, refer to FIG. 7) including a linear motor and the like, and is also drivable at a designated scanning velocity in a predetermined scanning direction (to be the Y-axis direction that is a direction orthogonal to the page surface in FIG. 1, in this case).

The position of reticle stage RST within a stage-moving plane is constantly detected at a resolution of, for example, approximately 0.5 to 1 nm with a reticle laser interferometer (hereinafter referred to as a ‘reticle interferometer’) 16 via a movable mirror 15. In this case, the position measurement is performed using a fixed mirror 14, which is fixed on a side surface of a barrel 40 constituting projection unit PU to be described later, as a datum. In actual, a Y movable mirror having a reflection surface orthogonal to the Y-axis direction and an X movable mirror having a reflection surface orthogonal to the X-axis direction are arranged on reticle stage RST, and a reticle Y interferometer and a reticle X interferometer are arranged corresponding to these movable mirrors, and further a fixed mirror for X-axis direction position measurement and a fixed mirror for Y-axis direction position measurement are arranged corresponding to the interferometers. However, in FIG. 1, these parts are represented by movable mirror 15, reticle interferometer 16 and fixed mirror 14. One of the reticle Y interferometer and the reticle X interferometer, for example, the reticle Y interferometer is an interferometer that has two measurement axes, and not only the Y-position of reticle stage RST but also a rotation in the θz direction can be measured based on the measurement value of the reticle Y interferometer. Incidentally, for example, an end surface of reticle stage RST may be polished in order to form a reflection surface (corresponding to a reflection surface of movable mirror 15). Further, at least one corner cubic mirror (such as a retroreflector) may be used, instead of a reflection surface extending in the X-axis direction that is used for detecting the position of reticle stage RST in the scanning direction (the Y-axis direction in the embodiment).

A measurement value of reticle interferometer 16 is sent to main controller 20. Main controller 20 drives and controls reticle stage RST via reticle stage drive section RSC (refer to FIG. 7) based on the measurement value of reticle interferometer 16.

Projection unit PU is supported on a barrel supporting platform 38 that constitutes a part of the body, via a flange FLG1 below reticle stage RST in FIG. 1. Projection unit PU is composed of barrel 40 that has a cylindrical shape and has flange FLG1 arranged in the vicinity of a lower end portion of an outer periphery section of barrel 40, and projection optical system PL made up of a plurality of optical elements held in barrel 40.

As projection optical system PL, for example, a dioptric system that is composed of a plurality of lenses (lens elements) having an optical axis AX in common, for example, in the Z-axis direction. Projection optical system PL is, for example, a both-side telecentric reduction system that has a predetermined projection magnification (such as ¼ or ⅕). Therefore, when reticle R is illuminated with illumination light IL from illumination system 10, illumination light IL passing through reticle R forms a reduced image of a circuit pattern (a reduced image of a part of the circuit pattern) of reticle R within an illumination area (the irradiation area of illumination light IL) on wafer W which surface is coated with a resist (a photosensitive agent), via projection optical system PL.

In exposure apparatus 100 of the embodiment, because exposure to which the immersion method is applied is performed, the numerical aperture NA increases, which makes the opening on the reticle side larger. Therefore, in a dioptric system made of up only lenses, it becomes difficult to satisfy the Petzval condition, which tends to lead to an increase in the size of the projection optical system. In order to prevent such an increase in the size of the projection optical system, a catadioptric system composed including mirrors and lenses may also be used.

Further, in exposure apparatus 100, in the vicinity of a lens constituting projection optical system PL closest to the image plane side (the wafer W side) (hereinafter referred to as a ‘tip lens’) 91, a liquid supply nozzle 51A and a liquid recovery nozzle 51B that constitute liquid supply/drainage system 132 are arranged. Liquid supply nozzle 51A and liquid recovery nozzle 51B are held by barrel supporting platform 38, and are arranged so that their tips face wafer stage WST which will be described later.

The other end of a supply pipe (not shown) connects to liquid supply nozzle 51A, which one end connects to a liquid supply unit 131A (not shown in FIG. 1, refer to FIG. 7), and the other end of a recovery pipe (not shown) connects to liquid recovery nozzle 51B, which one end connects to a liquid recovery unit 131B (not shown in FIG. 1, refer to FIG. 7).

Liquid supply unit 131A is composed including a liquid tank, a compression pump, a temperature controller, a valve for controlling supply/stop of the liquid to the supply pipe, and the like. As the valve, for example, a flow rate control valve is preferably used so that not only the supply/stop of the liquid but also the flow rate can be adjusted. The temperature controller adjusts the temperature of the liquid within the liquid tank so that the temperature of the liquid is about the same level as the temperature within the chamber (not shown) where the exposure apparatus main body is housed.

Incidentally, the tank for supplying the liquid, the compression pump, the temperature controller, the valves, and the like do not all have to be equipped in exposure apparatus 100, and at least a part of them may be substituted by the equipment available in the factory where exposure apparatus 100 is installed.

Liquid recovery unit 131B is composed including a liquid tank, a suction pump, a valve for controlling recovery/stop via the recovery pipe, and the like. As the valve, a flow rate control valve is preferably used corresponding to the valve on a liquid supply unit 131A side.

Incidentally, the tank for recovering the liquid, the suction pump, the valves, and the like do not all have to be equipped in exposure apparatus 100, and at least a part of them may be substituted by the equipment available in the factory where exposure apparatus 100 is installed.

As the liquid, in this case, ultra pure water (hereinafter, it will simply be referred to as ‘water’ besides the case when specifying is necessary) that transmits the ArF excimer laser beam (light with a wavelength of 193 nm) is to be used. Ultra pure water can be obtained in large quantities at a semiconductor manufacturing plant or the like without difficulty, and it also has an advantage of having no adverse effect on the photoresist on the wafer, to the optical lenses or the like. Further, ultra pure water has no adverse effect on the environment as well as an extremely low concentration of impurities, therefore, cleaning action on the surface of wafer W and the surface of tip lens 91 can be anticipated.

Refractive index n of the water with respect to the ArF excimer laser beam is said to be around 1.44. In the water the wavelength of illumination light IL is 193 nm×1/n, shorted to around 134 nm.

Liquid supply unit 131A and liquid recovery unit 131B both have a controller, and the controllers operate under the control of main controller 20 (refer to FIG. 7). According to instructions from main controller 20, the controller of liquid supply unit 131A opens the valve connected to the supply pipe to a predetermined degree to supply water in the space between tip lens 91 and wafer W via liquid supply nozzle 51A. Further, when the water is supplied, according to instructions from main controller 20, the controller of liquid recovery unit 131B opens the valve connected to the recovery pipe to a predetermined degree to recover the water from the space between tip lens 91 and wafer W into liquid recovery unit 131B (the liquid tank) via liquid recovery nozzle 51B. During the supply and recovery operations, main controller 20 gives orders to the controllers of liquid supply unit 131A and liquid recovery unit 131B so that the amount of water supplied to the space between tip lens 91 and wafer W from liquid supply nozzles 51A constantly equals the amount of water recovered via recovery nozzle 51B. Accordingly, a constant amount of water Lq (refer to FIG. 1) is held in the space between tip lens 91 and wafer W. In this case, water Lq held in the space between tip lens 91 and wafer W is constantly replaced.

As is obvious from the above description, liquid supply/drainage system 132 in the embodiment is a liquid supply/drainage system for local immersion that is configured including liquid supply unit 131A, liquid recovery unit 131B, the supply pipe, the recovery pipe, liquid supply nozzle 51A and liquid recovery nozzle 51B, and the like.

Incidentally, in the above description, the case has been described where one liquid supply nozzle and one liquid recovery nozzle are arranged, in order to simplify the description. However, the present invention is not limited to this, and the configuration having multiple nozzles as disclosed in, for example, the pamphlet of the International Publication No. 99/49504, may be employed. The point is that any configuration may be used as far as the liquid can be supplied in the space between an optical member in the lowest end (a tip lens) 91 constituting projection optical system PL and wafer W.

As is shown in FIG. 1, wafer stage WST is supported by levitation in a non-contact manner via a plurality of air bearings arranged on the bottom surface of wafer stage above the upper surface of a stage base BS that is horizontally arranged below projection unit PU. On wafer stage WST, wafer W is fixed by vacuum suction (or electrostatic suction) via a wafer holder 70. A surface on a +Z side (an upper surface) of stage base BS is processed so that the degree of flatness becomes so high, and this surface serves as a guide plane that is a movement datum plane of wafer stage WST.

Below projection optical system PL in FIG. 1, wafer stage WST is driven along the guide plane described above within an XY plane (including the θz direction) by wafer stage drive section WSC (not shown in FIG. 1, refer to FIG. 7) that includes an actuator such as a liner motor (or a planar motor), and finely driven in directions of three degrees of freedom, which are the Z-axis direction, a θx direction (a rotation direction around the X-axis) and a θy direction (a rotation direction around the Y-axis).

As is shown in FIG. 2, wafer holder 70 comprises a main body section 70A having a plate shape and an auxiliary plate 72 fixed on the upper surface of main body section 70A, on which a circular opening having a diameter 0.1 to 1 mm larger than a diameter of wafer W is formed in the center. In an area inside the circular opening of auxiliary plate 72, multiple pins are arranged, and wafer W is held by vacuum suction in a state supported by the multiple pins. In this case, in a state where wafer W is held by vacuum suction, the surface of wafer W and the surface of auxiliary plate 72 are set to substantially the same height.

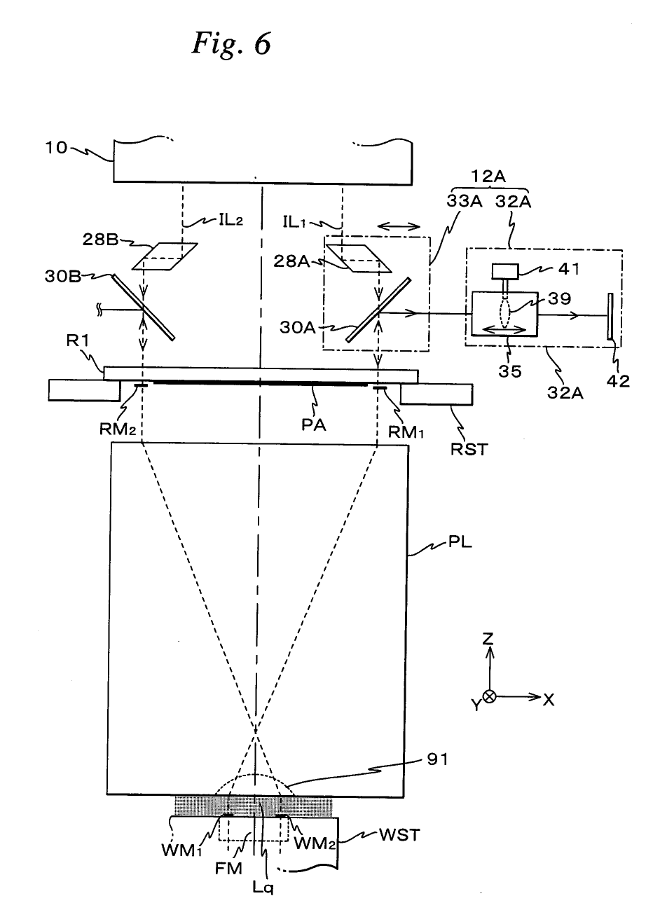

Further, a rectangular-shaped opening is formed in a part of auxiliary plate 72, and a fiducial mark plate FM is fitted into the opening. A surface of fiducial mark plate FM is made to be coplanar with auxiliary plate 72. On the surface of fiducial mark plate FM, at least one pair of first fiducial marks WM₁ and WM₂ for reticle alignment (not shown in FIG. 2, refer to FIG. 6), second fiducial marks (not shown) for baseline measurement of an off-axis alignment system that have a known positional relation with first fiducial marks WM₁ and WM₂, and the like are formed.

Referring back to FIG. 1, position information related wafer stages WST within the XY plane is constantly detected by a wafer laser interferometer (hereinafter referred to as a ‘wafer interferometer’) 18, which irradiates a measurement beam to a movable mirror 17XY fixed to an upper portion of wafer stages WST, at a resolution of, for example, around 0.5 to 1 nm. Wafer interferometer 18 is fixed to barrel supporting platform 38 in a suspended state, and measures position information of a reflection surface of movable mirror 17XY using, as a datum, a reflection surface of a fixed mirror 29XY fixed to a side surface of barrel 40 constituting projection unit PU, as position information of wafer stage WST within the XY plane.

In actual, as shown in FIG. 2, a Y movable mirror 17Y having a reflection surface orthogonal to the Y-axis direction that is a scanning direction and an X movable mirror 17X having a reflection surface orthogonal to the X-axis direction that is a non-scanning direction are arranged on wafer stage WST, and laser interferometers and fixed mirrors for an X-axis direction position measurement and for a Y-axis direction position measurement are respectively arranged corresponding to these movable mirrors. However, in FIG. 1, they are represented by movable mirror 17XY, wafer interferometer 18 and fixed mirror 29XY. Incidentally, for example, an end surface of wafer stage WST may be polished in order to form a reflection surface (corresponding to the reflection surface of movable mirror 17XY). Further, the laser interferometer for X-axis direction position measurement and the laser interferometer for Y-axis direction position measurement of wafer interferometer 18 are both multi-axis interferometers that have a plurality of measurement axes, and with these interferometers, besides the X and Y positions of wafer stage WST, rotation (yawing (rotation in the θz direction)), pitching (rotation in the θx direction) and rolling (rotation in the θy direction) can also be measured.

Further, as is shown in FIGS. 1 and 2, a reflection mirror 17Z is arranged on wafer stage WST at an inclination of 45 degrees at the end portion in a −X direction of wafer stage WST, and wafer interferometer 18 also irradiates a measurement beam that is parallel to the X-axis toward reflection mirror 17Z. The beam reflected off reflection mirror 17Z to a +Z side is reflected to a −Z side by a fixed mirror 29Z that is arranged on a −Z side surface of barrel supporting platform 38 and extends in the X-axis direction, and then the beam is reflected off reflection mirror 17Z again to return to wafer interferometer 18. Wafer interferometer 18 makes this returning beam and the returning beam of the measurement beam for X-axis direction position measurement interfere, and also detects position information of wafer stage WST in a direction of optical axis AX of projection optical system PL (the Z-axis direction), that is, the Z position of wafer stage WST with detection accuracy of the same level as the detection accuracy of the XY-position.

In the embodiment, a length of fixed mirror 29Z in the X-axis direction is set so that wafer interferometer 18 can constantly monitor the Z position of wafer stage WST even while wafer stage WST is moving between a position directly below projection optical system PL, a position directly below alignment system ALG to be described later, and a position at which wafer W is loaded. With this structure, the absolute Z-position of wafer stage WST can be constantly detected by the same wafer interferometer 18 regardless of the XY position of wafer stage WST.

Position information (or velocity information) of wafer stage WST including the Z position described above is sent to main controller 20. Main controller 20 controls the positions in directions of six degrees of freedom including the position within the YX plane and the Z position of wafer stage WST via wafer stage drive section WSC (not shown in FIG. 1, refer to FIG. 7), based on the position information (or the velocity information) of wafer stage WST.

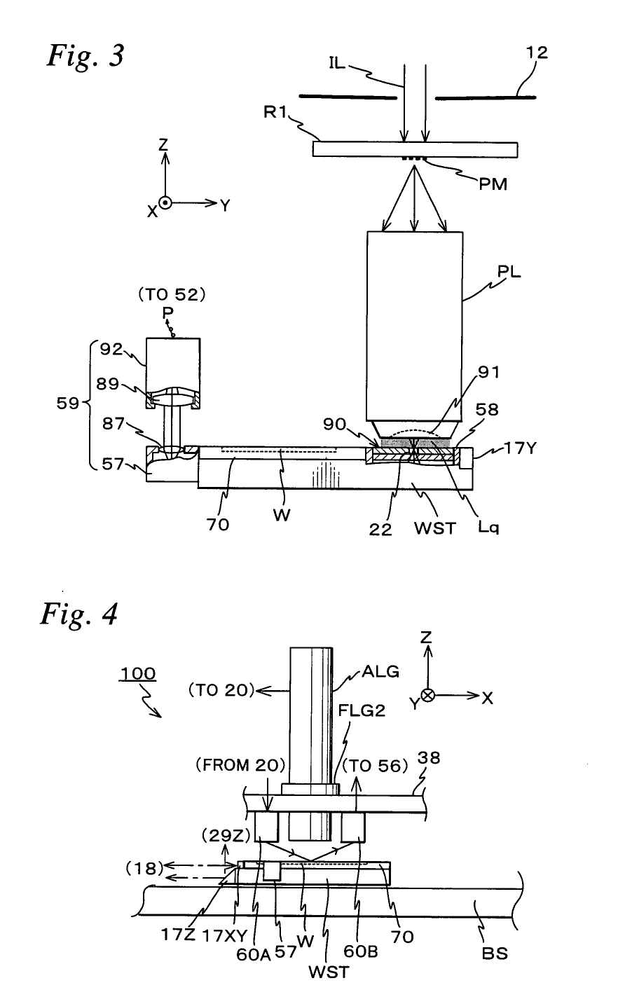

Further, exposure apparatus 100 is equipped with an aerial image measurement unit that measures an aerial image via projection optical system PL. As is shown in FIG. 3, a part of an optical system constituting an aerial image measurement unit 59 is arranged inside wafer stage WST. Aerial image measurement unit 59 is composed including a section on a stage side arranged on wafer stage WST, that is, a slit plate 90 and a light transmitting lens 87, and a section outside the stage arranged outside wafer stage WST, that is, a photodetection lens 89, a light sensor made up of photoelectric conversion elements, and a signal processing circuit 52 (refer to FIGS. 1 and 7) for photoelectric conversion signal from the light sensor, and the like.

As is shown in FIG. 3, slit plate 90 is arranged in a protruding section 58, which is arranged on the upper surface of wafer stage WST and has an opening in its upper portion, so as to be fixed from above in a state where the opening of protruding section 58 is covered with, and also slit plate 90 is fixed to wafer stage WST in a state where an upper surface of slit plate 90 is located substantially coplanar with wafer W that is held by vacuum suction by wafer holder 70. Slit plate 90 is made up of a glass having high transmittance to illumination light IL (synthetic quartz, or fluorite), and has a light shielding film formed on the upper side, and as is shown in FIG. 2, two slit-shaped measurement patterns 22X and 22Y that have a predetermined width, and extend in the X-axis direction and the Y-axis direction respectively are formed on the light shielding film. In the following description, measurement patterns 22X and 22Y will be generally referred to as a slit 22, and for the sake of convenience the explanation will be made on the assumption that slit 22 is formed on slit plate 90. In this case, a surface of slit plate 90 is set to have an extremely high degree of flatness, and slit plate 90 also serves as a so-called datum plane plate.

Measurement of a projected image (an aerial image) of a measurement mark formed on reticle R by aerial image measurement unit 59 via projection optical system PL is performed based on the so-called slit-scan method. In the aerial image measurement based on the slit-scan method, slit 22 of slit plate 90 is scanned with respect to a projected image (an aerial image) of a measurement mark via projection optical system PL, illumination IL passing though the slit during the scanning is guided outside wafer stage WST by light transmitting lens 87 arranged on an extending section 57 via an optical system inside wafer stage WST. Then, the light guided outside wafer stage WST enters photodetection lens 89 that is attached to a case 92 fixed to barrel supporting platform 38 (refer to FIG. 1) and has a diameter larger than a diameter of light transmitting lens 87 (larger enough for receiving the light from light transmitting lens 87 during the slit-scan without fail). The incident light is received by a photoelectric conversion element (a photodetection element) attached to a position conjugate with slit 22 within case 92, for example, a light sensor such as a photo multiplier tube (PMT) via photodetection lens 89. A photoelectric conversion signal (a light amount signal) P corresponding to the light amount from the light sensor is outputted to main controller 20 via signal processing circuit 52 that is composed including an amplifier, an A/D converter (such as the one having the resolution of 16 bit) and the like. Main controller 20 detects the light intensity of the projected image (the aerial image) based on the photoelectric conversion signal from the light sensor that received the light.

Incidentally, when performing the aerial image measurement described above, as in the space between tip lens 91 and wafer W, a constant amount of water Lq (refer to FIG. 3) is also held in the space between tip lens 91 and slit plate 90 by the control of the controllers of liquid supply unit 131A and liquid recovery unit 131B according to instructions from main controller 20.

In FIG. 3, a state is shown where an aerial image of a measurement mark formed on a reticle R1 held on reticle stage RST, instead of reticle R, is being measured using aerial image measurement unit 59. A measurement mark PM that is made up of L/S patterns having the periodicity in the Y-axis direction is to be formed at a predetermined point on reticle R1. In addition, when measuring an aerial image, a movable reticle blind 12 constituting illumination system 10 is to be driven by main controller 20 via a blind drive unit (not shown) and an illumination area of illumination light IL on reticle R1 is to be set to only a portion corresponding to measurement mark PM. In this state, when illumination light IL is irradiated to reticle R1, as is shown in FIG. 3, the light (illumination light IL) diffracted or scattered by measurement mark PM is refracted by projection optical system PL and an aerial image (a projected image) of measurement mark PM is formed on an image plane of projection optical system PL.

In a state where the aerial image is formed, when wafer stage WST is driven in the Y-axis direction by main controller 20 via wafer stage drive section WSC (refer to FIG. 7), slit 22 is scanned with respect to the aerial image along the Y-axis direction. Then, the light (illumination light IL) passing through slit 22 during the scanning is received by the light sensor of aerial image measurement unit 59, and photoelectric conversion signal P of the received light is supplied to main controller 20 via signal processing circuit 52. Main controller 20 can measure a light intensity distribution corresponding to the aerial image based on photoelectric conversion signal P. However, since photoelectric conversion signal (light intensity signal) P obtained on the aerial image measurement is a convolution of a function relying on slit 22 and the light intensity distribution corresponding to the aerial image, in order to obtain a signal corresponding to the aerial image, a deconvolution related to the function relying on slit 22 needs to be performed in, for example, signal processing circuit 52 or the like.

Referring back to FIG. 1, on the +X side of projection unit PU, alignment system ALG by an off-axis method is supported on barrel supporting platform 38 via a flange FLG2. As alignment system ALG, for example, an alignment sensor of a FIA (Field Image Alignment) system based on an image-processing method is used, which irradiates a target mark with a broadband detection beam that does not expose the resist on wafer W, picks up the image of the target mark formed on the photodetection surface by the reflected light from the target mark and the image of an index (not shown) using an imaging device (such as a CCD), and outputs the imaging signals. The imaging results of alignment system ALG is sent to main controller 20.

Further, in exposure apparatus 100, a multiple focal point position detection system (hereinafter appropriately referred to as a ‘multipoint AF system’) is arranged that is made up of an irradiation system 60A and a photodetection system 60B arranged sandwiching alignment system ALG. Irradiation system 60A has a light source which on/off is controlled by main controller 20, and irradiates a plurality of image-forming beams to form an image of a slit (or a pin hole) toward a surface of wafer W from an oblique direction with respect to optical axis AX in the case wafer W is located directly below alignment system ALG. Photodetection system 60B receives the image-forming beams reflected off the surface of wafer W. In other words, the multi point AF system is a focal point position detection system by an oblique incident method that detects the position of wafer W in the optical axis AX direction (the Z-axis direction) and the gradient of wafer W with respect to the XY plane. As the multipoint AF system (60A, 60B) in the embodiment, the configuration similar to the one disclosed in, for example, Kokai (Japanese Unexamined Patent Application Publication) No. 06-283403, and the corresponding U.S. Pat. No. 5,448,332, and the like is used. In the embodiment, however, the multipoint AF system is not arranged in the vicinity of projection optical system PL (further, so as to have the optical axis of the projection optical system as the center), but is arranged in the vicinity of alignment system ALG. As long as the national laws in designated states (or elected states), to which this international application is applied, permit, the above disclosures of the publication and the U.S. Patent are incorporated herein by reference.

In irradiation system 60A, for example, an illumination light source, a pattern plate where 64 slit-shaped aperture patterns in a matrix arrangement of 8 rows and 8 columns, as an example, are formed, an irradiation optical system and the like are arranged. In addition, in photodetection system 60B, a photodetection slit plate where 64 slits in total in a matrix arrangement of 8 rows and 8 columns, as an example, are formed, a focus sensor serving as a sensor that is made up of photodetection elements such as 64 photodiodes arranged in a matrix arrangement of 8 rows and 8 columns facing the respective slits of the slit plate, a rotation direction vibrating plate, a photodetection optical system and the like are arranged.

The operations of each part of the multipoint AF system (60A, 60B) will be briefly described next. When the pattern plate is illuminated by an illumination light from the illumination light source within irradiation system 60A under instructions from main controller 20, as is shown in FIG. 4 for example, an image-forming beam passing through each aperture pattern of the pattern plate is irradiated to a surface of wafer W via the irradiation optical system, and images of the slit-shaped aperture patterns (slit images) S₁₁ to S₈₈ in the 8 rows and 8 columns matrix arrangement, which are 8×8=64 in total, are formed on the surface of wafer W at an inclination of 45 degrees with respect to the X-axis and the Y-axis. Then, the image-forming beam of each of slit images S₁₁ to S₈₈ reflected off the wafer surface forms the image again on each slit of the photodetection slit plate via the photodetection optical system, and the beams of the slit images are individually received by the focus sensor. In this case, because the beams of the slit images are vibrated by the rotation direction vibrating plate, the position of each image that is formed again (hereinafter appropriately referred to as a ‘reflection slit image’) is vibrated in a direction intersecting with a longitudinal direction of each slit on the photodetection slit plate. Each detection signal of the focus sensor is synchronously detected by a signal processing unit 56 in FIG. 1 using the signal of the frequency of the rotation direction vibrating plate. Then, the 64 focus deviation signals (defocus signals) that are obtained by the synchronous detection, for example, the S-curve signals are supplied by signal processing unit 56 to main controller 20.

The S-curve signal is a signal that becomes a zero level when the slit center of the photodetection slit plate coincides with the vibration center of the reflection slit image from wafer W, becomes a plus level when wafer W is displaced upward from such a state, and becomes a minus level when wafer W is displaced downward. Accordingly, in a state where an offset is not added to the S-curve signal, the height positions of wafer W where the S-curve signal becomes a zero level are severally detected at each slit image by main controller 20.

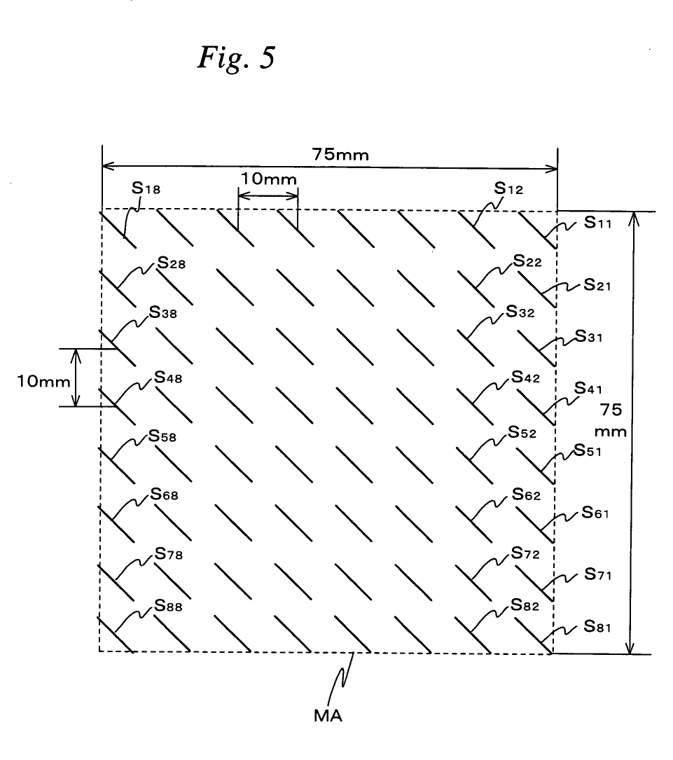

Incidentally, in the following description, the place on wafer W where slit images S₁₁ to S₈₈ shown in FIG. 5 are formed and the Z position from the image-forming plane is detected is to specifically be called measurement points S₁₁ to S₈₈. As is shown in FIG. 5, a distance between the centers of the adjacent slit images are set to, for example, 10 mm in both the X-axis direction and the Y-axis direction. Since a degree of flatness of a surface of a process wafer has recently been increased due to a CMP process or the like and a global surface shape only has to be measured, the distance of such a level is enough. Further, the length of each measurement point in the X-axis direction and the Y-axis direction is set to, for example, to 5 mm. In this case, a size of an area that all slit images S₁₁ to S₈₈ cover is 75×75=5625 mm². Accordingly, with the multipoint AF system (60A, 60B), the Z position and an inclination component of the wafer of 75×75 (=5625) mm² can be measured at one time. In the following description, the measurement area of the multiple AF system (60A, 60B) is referred to as MA.

Referring back to FIG. 1, above reticle R, a pair of reticle alignment detection systems (hereinafter referred to as ‘RA detection systems’ for the sake of convenience) 12A and 12B are arranged. The pair of reticle alignment detection systems are composed of an alignment system by the TTR (Through the Reticle) method that uses an exposure wavelength for simultaneously observing a pair of reticle alignment marks (RA marks) on reticle R and the images of a pair of first fiducial marks, for example, WM₁ and WM₂ on fiducial mark plate FM corresponding to the RA marks via projection optical system PL. The detection signals of RA detection systems 12A and 12B are supplied to main controller 20 via an alignment controller (not shown).

Next, based on FIG. 1 and FIG. 6 that enlargedly shows the details of RA detection system 12A in FIG. 1, RA detection systems 12A and 12B will be described further in detail. One of the RA detection systems, RA detection system 12A is configured including two sections, i.e. a movable section 33A and a fixed section 32A, as is shown in FIG. 1. Of two sections, movable section 33A comprises a prism 28A, a beam splitter 30A arranged below prism 28A at an inclination of 45 degrees, and a housing holding prism 28A and beam splitter 30A in a predetermined positional relation, as is shown in FIG. 6. Movable section 33A is arranged freely movable in the X-axis direction, and when reticle alignment to be described later is performed, movable section 33A is moved to a measurement position (a position shown in FIG. 6) in an optical path of illumination light IL by a drive unit (not shown) according to orders from main controller 20, and when the reticle alignment is completed, movable section 33A is withdrawn from the optical path of illumination light IL by the drive unit (not shown) under orders from main controller 20 so as not to hinder the exposure operations.

Prism 28A is to guide illumination light IL to a RA mark (e.g. RM₁) on reticle R when prism 28A is located at the measurement position in FIG. 6. Since the RA mark is arranged outside a pattern area PA and this portion is a portion that does not normally need to be illuminated, a beam that is a part of illumination light IL (hereinafter the beam is referred to as an ‘IL₁’for the sake of convenience) is guided to the portion in the embodiment. Beam IL₁ guided by prism 28A illuminates the RA mark (e.g. RM₁) via beam splitter 30A. Beam splitter 30A is to guide a detection beam (a reflected beam of beam IL₁) from a reticle R side to fixed section 32A.

Fixed section 32A is composed including an image-forming optical system 35, a drive unit 41 that drives a focused-state adjustment lens 39 arranged within image-forming optical system 35, an imaging device (CCD) 42 and the like.

As image-forming optical system 35, in this case, an optical system that can change a focal distance by driving focused-state adjustment lens 39 arranged inside, that is, the so-called internal focusing optical system is used. Therefore, in the embodiment, main controller 20 obtains the contrast of light intensity signals corresponding to the projected images of the RA mark (e.g. RM₁) and the first fiducial mark (e.g. WM₁) on fiducial mark plate FM, for example, by processing the image signals in imaging device 42, and drives focused-state adjustment lens 39 in the optical axis direction via drive unit 41 so that the contrast reaches the peak, and therefore a focal point of image-forming optical system 35 can be focused on a pattern surface of reticle R and a photodetection surface of imaging device 42. That is, the focusing operations of image-forming optical system 35 can be performed.

As is shown in FIGS. 1 and 6, the other RA detection system, RA detection system 12B comprises a movable section 33B and a fixed section 32B, and movable section 33B comprises a prism 28B and a beam splitter 30B. RA detection system 12B is configured similar to RA detection system 12A though they are symmetrically configured (a relation between an illumination light IL₂, a RA mark RM₂ on reticle R and a first fiducial mark WM₂ is also symmetric). Since the configuration of RA detection system 12B is same as that of RA detection system 12A, the same reference numerals as in RA detection system 12A are to be used for an image-forming optical system, a focused-state adjustment lens, a drive unit, and an imaging device in the following description. Incidentally, for example, also when reticle alignment is performed using the RA detection systems (12A, 12B), a constant amount of water Lq (refer to FIG. 3) is held in the space between tip lens 91 and fiducial mark plate FM by the control of the controllers of liquid supply unit 131A and liquid recovery unit 131B according to instructions from main controller 20.

Referring back to FIG. 1, a control system is mainly composed of main controller 20. Main controller 20 is configured including the so-called microcomputer (or workstation) made up of internal memory such as CPU (Central Processing Unit), ROM (Read Only Memory), RAM (Random Access Memory) and the like, and performs the overall control of, for example, the synchronous scanning of reticle R and wafer W, the stepping of wafer W, the exposure timing and the like so that the exposure operations are appropriately performed.

Next, a series of exposure operations in exposure apparatus 100 in the embodiment will be described in detail. As is described above, in exposure apparatus 100 of the embodiment, measurement area MA of the multipoint AF system (60A, 60B) is not positioned in the optical axis of projection optical system PL but is positioned at the position corresponding to a detection field of alignment system ALG by the off-axis method, which is different from an exposure apparatus as disclosed in Kokai (Japanese Unexamined Patent Application Publication) No. 06-349701 and the like. In other words, in exposure apparatus 100 of the embodiment, because a measurement point surface of the multipoint AF system is not located in optical axis AX, autofocus leveling control cannot be performed while detecting a surface position of wafer W in real time during scanning exposure using the multipoint AF system. Therefore, in exposure apparatus 100 of the embodiment, when detecting wafer alignment marks in fine alignment, information related to a surface shape of a surface subject to exposure of wafer W is also detected using the multipoint AF system (60A, 60B), and during scanning exposure, autofocus leveling control of wafer W during the scanning exposure is performed using the information related to a surface shape of the surface subject to exposure of wafer W detected beforehand.

In the case the autofocus leveling control of wafer W during exposure is performed using the information related to a surface shape of the surface subject to exposure of wafer W detected beforehand, calibration related to a detection system that detects the information needs to be performed with good accuracy. Next, information to be detected in the calibration will be described.

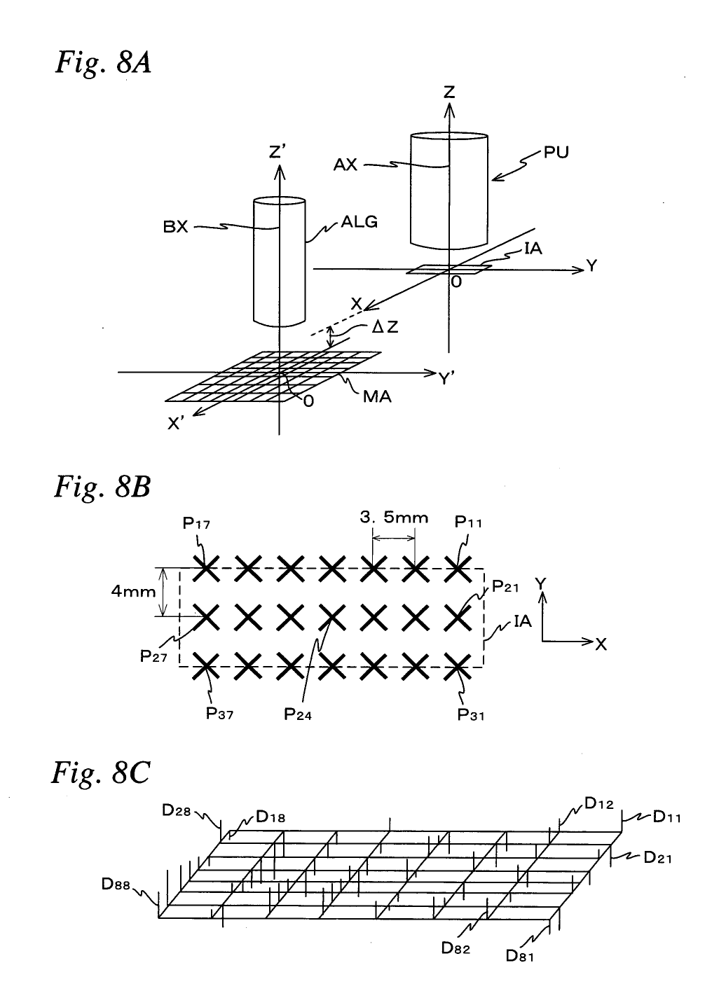

FIG. 8A shows an XYZ coordinate system where the optical system of projection optical system PL serves as the Z-axis and the best focus position on optical axis AX of projection optical system PL serves as the origin, and an X′Y′Z′ coordinate system where the center of measurement area MA of the multipoint AF system (60A, 60B) serves as the origin and that is made up of an X′-axis, a Y′-axis and a Z′-axis that are parallel to the X-axis, the Y-axis and the Z-axis respectively. As a premise, the Z′-axis is to coincide with a center axis BX of the detection field of alignment system ALG. As is shown in FIG. 8A, in the embodiment, the origins of both coordinate systems do not coincide with each other, as a matter of course. In addition, a deviation (ΔZ) naturally occurs also between the best focus position in optical axis AX of projection optical system PL and the Z position of the detection origin of the multipoint AF system (60A, 60B).

Further, as is shown in FIG. 8B, the best focus position of projection optical system PL is slightly different at each point within an exposure area (to be an exposure area IA) serving as an effective exposure field, due to aberration in projection optical system PL and the like. That is, even if the best focus position in optical axis AX of projection optical system PL is made to be the origin, the best focus position of projection optical system PL is not always located within a plane of Z=0 at other points within exposure area IA. Therefore, in the embodiment, the best focus position is measured severally at measurement points P₁₁ to P₃₇ that are arranged, for example, at 3.5 mm intervals in the X-axis direction and, for example, at 4 mm intervals in the Y-axis direction within exposure area IA as is shown in FIG. 8B, using aerial image measurement unit 59 or the like, and the best image-forming plane that is formed by the best focus positions of a plurality of measurement points P₁₁ to P₃₇ is obtained. In actual scanning exposure, the open autofocus leveling control is performed so that a surface subject to exposure of wafer W is made to conform to the best focus plane within a range of depth-of-focus.

Further, in the multipoint AF system (60A, 60B), since the Z position at each of measurement points S₁₁ to S₈₈ is detected independently by a plurality of focus sensors, a deviation necessarily occurs in the detection origin of the Z-position at each measurement point. It is difficult to mechanically reduce the deviation in the detection origins of all focus sensors to zero, and thus, in the embodiment, the deviation in the detection origins is outputted as an offset component at each measurement point. FIG. 8C shows a model of an example of offset components D₁₁to D₈₈ at measurement points S₁₁ to S₈₈. Such offset components become differences in the information related to a surface shape of the surface subject to exposure of wafer W detected by the multipoint AF system (60A, 60B), and therefore, offset components of D₁₁ to D₈₈ need to be detected as calibration information, prior to the detection of the surface shape in actual.

In other words, in the embodiment, calibration of the best image-forming plane of projection optical system PL and measurement area MA formed by the detection origins of a plurality of measurement points of the multipoint AF system (60A, 60B) needs to be performed, before exposure.

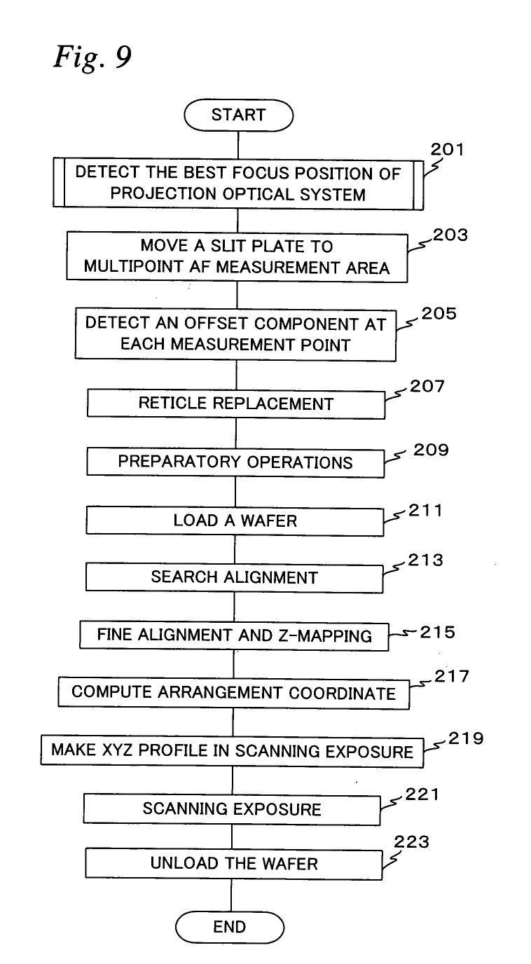

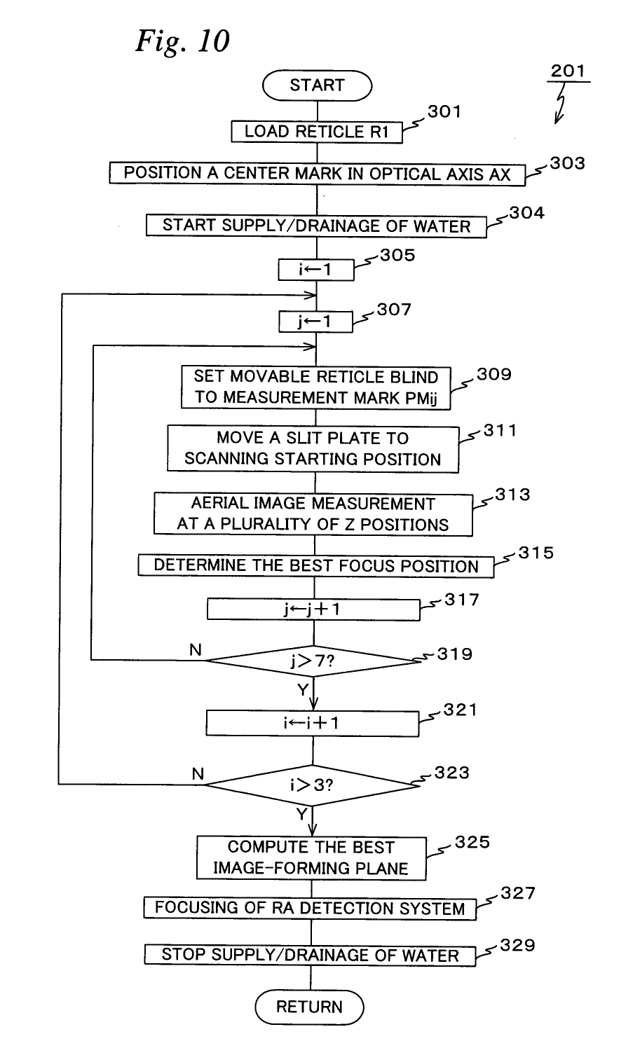

FIG. 9 shows a flowchart showing a processing algorithm of main controller 20 when performing exposure to one wafer. As is shown in FIG. 9, first, in subroutine 201, the best focus position of projection optical system PL is detected. In other words, in subroutine 201, as is shown in FIG. 10, first in step 301, reticle R1 is loaded on reticle stage RST by a reticle loader (not shown). Reticle R1 is a reticle on which measurement marks PM (refer to FIG. 3, to be measurement marks PMᵢⱼ (i=1 to 3, j=1 to 7) in this case) are formed at points corresponding to a plurality of measurement points P₁₁ to P₃₇ in exposure area IA shown in FIG. 8B.

In the next step, step 303, reticle stage RST is aligned so that a center mark positioned at the center on reticle R1 (a measurement mark PM₂₄ corresponding to a measurement point P₂₄ shown in FIG. 8B) coincides with the optical axis of projection optical system PL. In the next step, step 304, supply/drainage of water Lq by supply/drainage system 132 starts. With this operation, the space between tip lens 91 and slit plate 90 is filled with water Lq. Next, in step 305, a value of a counter i (hereinafter referred to as a ‘counter value i’) indicating the row number of the measurement mark is initialized to one, and in the next step, step 307, a value of a counter j (hereinafter referred to as a ‘counter value j’) indicating the column number of the measurement mark is initialized to one. Then, in step 309, an illumination area is set by driving and controlling movable reticle blind 12 constituting illumination system 10 so that illumination light IL is irradiated only to a portion of measurement mark PMᵢⱼ.

In the next step, step 311, wafer stage WST is driven via wafer stage drive section WSC so that slit plate 90 is moved to a scanning starting position where slit scanning of an aerial image of measurement mark PMᵢⱼ (measurement mark PM₁₁ in this case) can be performed. In the next step, step 313, aerial image measurement of measurement mark PMᵢⱼ (measurement mark PM₁₁ in this case) is repeatedly performed using aerial image measurement unit 59 based on the slit-scan method by irradiating illumination light IL to reticle R1, while shifting the Z position of wafer stage WST in a predetermined step pitch. When performing the aerial image measurement at each Z position, the Z-position of wafer stage WST is controlled via wafer stage drive section WSC based on the Z position of wafer stage WST measured by wafer interferometer 18. Further, a gradient of slit plate 90, that is, a gradient of wafer stage WST with respect to the XY plane that is orthogonal to optical axis AX of projection optical system PL is controlled to be at a desired constant angle (for example, so that both the pitching and the rolling become zero), based on the measurement values of wafer interferometer 18, more accurately, the measurement values of a pair of a Y interferometer (serving as a pitching interferometer) and an X interferometer (serving as a rolling interferometer) that have a measurement axis for detecting the pitching and the rolling of wafer stage WST, respectively. Then, in the next step, step 315, a Z position Zᵢⱼ, at which the contrast curve related to the aerial image of measurement mark PMᵢⱼ that has been obtained based on the measurement results of the aerial image indicates a peak value, is computed, and position Zᵢⱼ is stored in an internal memory as the best focus position at an evaluation point Pᵢⱼ.

Incidentally, when the Z position of wafer stage WST is changed, the distance between tip lens 91 and wafer W also changes, and therefore, an amount of water Lq held in the space between them is also changed appropriately by liquid supply/drainage system 132.

In the next step, step 317, counter value j is incremented by one (j←j+1). Then, in the next step, step 319, the judgment is made of whether or not counter value j exceeds 7. In this case, since counter value j is 2, the judgment is denied and the procedure returns to step 309.

Afterward, until counter value j exceeds 7 and the judgment is affirmed in step 319, the processing and judgment of steps 309→311→313→315→317→319 are repeatedly executed, and the aerial image measurement of measurement marks PM₁₂ to PM₁₇ at measurement points P₁₂ to P₁₇ is performed at a plurality of Z positions, and best focus positions Z₁₁ to Z₁₇ at the measurement points are detected and stored in the internal memory.

When counter value j exceeds 7 and the judgment in step 319 is affirmed, the procedure proceeds to step 321. In step 321, counter value i is incremented by one (i←i+1). In the next step, step 323, the judgment is made of whether or not counter value i exceeds 3. In this case, since counter value i equals 2, the judgment is denied, and the procedure returns to step 307.

Afterward, until counter value i equals 4 and the judgment is affirmed in step 323, the processing and judgment of steps 307→309→311→313→315→317→319 are repeatedly executed, and the aerial image measurement of measurement marks PM₂₁ to PM₂₇ at measurement points P₂₁ to P₂₇ is performed at a plurality of Z positions, and best focus positions Z₂₁ to Z₂₇ at the measurement points are detected and stored in the internal memory. Then, the processing and judgment of steps 307→309→311→313→315→317→319 are repeatedly executed further one more time, and the aerial image measurement of measurement marks PM₃₁ to PM₃₇ at measurement points P₃₁ to P₃₇ is performed at a plurality of Z positions, and best focus positions Z₃₁ to Z₃₇ at the measurement points are detected and stored in the internal memory.

When counter value i becomes 4 and the judgment in step 323 is affirmed, the procedure proceeds to step 325. In step 325, an approximate plane of an image plane of projection optical system PL (and an image plane shape) is computed by performing a predetermined statistical processing based on best focus positions Z₁₁, Z₁₂, . . . , Z₃₇ obtained in the above-described manner. On the computation, the field curvature can be computed separately from the image plane shape. Since the image plane of projection optical system PL, that is, the best image-forming plane is a plane made up of a group of best focus positions at a myriad of points which distances from the optical axis are different (that is, a myriad of points where the so-called heights of images are different), the image plane shape and the approximate plane of the image plane can be easily and accurately obtained in this manner.

In the next step, step 327, focusing of RA detection systems 12A and 12B is performed. First, as is shown in FIG. 6, wafer stage WST is moved to directly below projection optical system PL so that first fiducial marks WM₁ and WM₂ of fiducial mark plate FM on wafer stage WST come into the detection fields of RA detection systems 12A and 12B. When wafer stage WST is moved, the autofocus leveling control is performed to wafer stage WST so that fiducial mark plate FM is positioned in the best image-forming plane of projection optical system PL. Incidentally, because an upper surface of wafer stage WST including wafer W is a substantially perfect plane, supply/drainage of water does not need to be stopped by liquid supply/drainage system 132.

Further, movable sections 33A and 33B of RA detection systems 12A and 12B shown in FIG. 6 are moved to above reticle R1 via a drive unit (not shown), and a pair of first fiducial marks WM₁ and WM₂ formed on fiducial mark plate FM on wafer stage WST is illuminated by illumination lights IL₁ and IL₂ via reticle R1 and projection optical system PL. With this operation, the reflected beams from a portion where first fiducial marks WM₁ and WM₂ exist return to both positions in the X-axis direction sandwiching pattern area PA of a pattern surface of reticle R1, then the projected images of first fiducial marks WM₁ and WM₂ are formed on the pattern surface of reticle R1. Incidentally, in this case, the RA marks on reticle R1 may be either outside or inside the fields of RA detection systems 12A and 12B. This is because all the RA marks and first fiducial marks WM1 and WM2 have known structures and they can be easily distinguished in the process of signal processing. Next, focused-state adjustment lens 39 within each image-forming optical system 35 that constitutes RA detection system 12A and 12B respectively is driven in a predetermined pitch or continuously along the optical axis within a predetermined range via drive unit 41. Then, detection signals outputted from the RA detection systems (12A, 12B) during the driving, that is, image intensity (light intensity) signals of first fiducial marks WM₁ and WM₂ are monitored, and based on the monitoring results, a position where each image-forming optical system 35 is in a focused state is determined, and an optical axis direction position of focused-state adjustment lens 39 is set at the position, then each image-forming optical system 35, which constitutes RA detection systems 12A and 12B respectively, is focused. The judgment regarding the focused-state can be made, as an example, by determining a position where the contrast of the light intensity signals reaches the peak, and setting the position as the focused position. As a matter of course, the focused state may be judged in other methods. With this operation, the best focus position of RA detection systems (12A, 12B) coincide with the best image-forming plane of projection optical system PL.

In the next step, step 329, supply/drainage of water is stopped by liquid supply/drainage system 132. Accordingly, the water below tip lens 91 is removed. When step 329 is completed, the procedure proceeds to step 203 in FIG. 9.

In the next step, step 203, wafer stage WST is moved via wafer stage drive section WSC so that slit plate 90 also serving as a datum plane plate as described above is positioned below alignment system ALG (that is, measurement area MA of the multipoint AF system). On this operation, a gradient of slit plate 90, that is, a gradient of wafer stage WST with respect to the XY plane orthogonal to optical axis AX of projection optical system PL is controlled to be at a desired constant angle (for example, so that both the pitching and the rolling become zero), based on the measurement values of wafer interferometer 18, more accurately, the measurement values of a pair of a Y interferometer (serving as a pitching interferometer) and an X interferometer (serving as a rolling interferometer) that have a measurement axis for detecting the pitching and the rolling of wafer stage WST, respectively. Further, main controller 20 adjusts the Z position of wafer stage WST to the position at which any measurement results of measurement points S₁₁ to S₈₈ (each measurement point on slit plate 90 in this case) that are measured by the multipoint AF system (60A, 60B) are not out of a measurement range and are not saturated.

In the next step, step 205, the measurement results of measurement point S₁₁ to S₈₈ are obtained, and the measurement results are stored in the internal memory as offset components D₁₁ to D₈₈ at measurement point S₁₁ to S₈₈ as is shown in FIG. 8C, and the Z position of wafer stage WST at the time of this operation is also stored in the internal memory.

Incidentally, in the case the measurement points at which measurement results are saturated still exist even if the Z position of wafer stage WST is adjusted, an adjustment member composing the multipoint AF system (60A, 60B), for example, a rotation amount of a parallel plate glass may be adjusted.

In the next step, step 207, reticle replacement is performed. With this operation, reticle R1 held on reticle stage RST is unloaded by a reticle unloader (not shown), and reticle R to be used for actual exposure is loaded by a reticle loader (not shown).

In the next step, step 209, preparatory operations such as reticle alignment and baseline measurement are performed in the same procedures as in the normal scanning stepper, using the reticle alignment systems (12A, 12B), fiducial mark plate FM and the like. Incidentally, of the preparatory operations, the reticle alignment is performed in a state where water Lq is supplied in the space between tip lens 91 and fiducial mark plate FM by liquid supply/drainage system 132. After the reticle alignment, supply/drainage of water is stopped.

In the next step, step 211, wafer stage WST is moved to a loading position, and wafer W is loaded on wafer stage WST by a wafer loader (not shown). In the next step, step 213, search alignment is performed. With regard to the search alignment, the method similar to the one whose details are disclosed in, for example, Kokai (Japanese Unexamined Patent Application Publication) No. 02-272305 and the corresponding U.S. Pat. No. 5,151,750, and the like is used. As long as the national laws in designated states (or elected states), to which this international application is applied, permit, the above disclosures of the publication and the U.S. Patent are incorporated herein by reference.

In the next step, step 215, wafer stage WST is moved to directly below alignment system ALG, and wafer alignment (fine alignment) is performed to wafer W on wafer stage WST. In this case, as an example, the wafer alignment based on the EGA (Enhanced Global Alignment) method, which details are disclosed in, for example, Kokai (Japanese Unexamined Patent Application Publication) No. 61-044429 and the corresponding U.S. Pat. No. 4,780,617, and the like, is performed. As long as the national laws in designated states (or elected states), to which this international application is applied, permit, the above disclosures of the publication and the U.S. Patent are incorporated herein by reference.

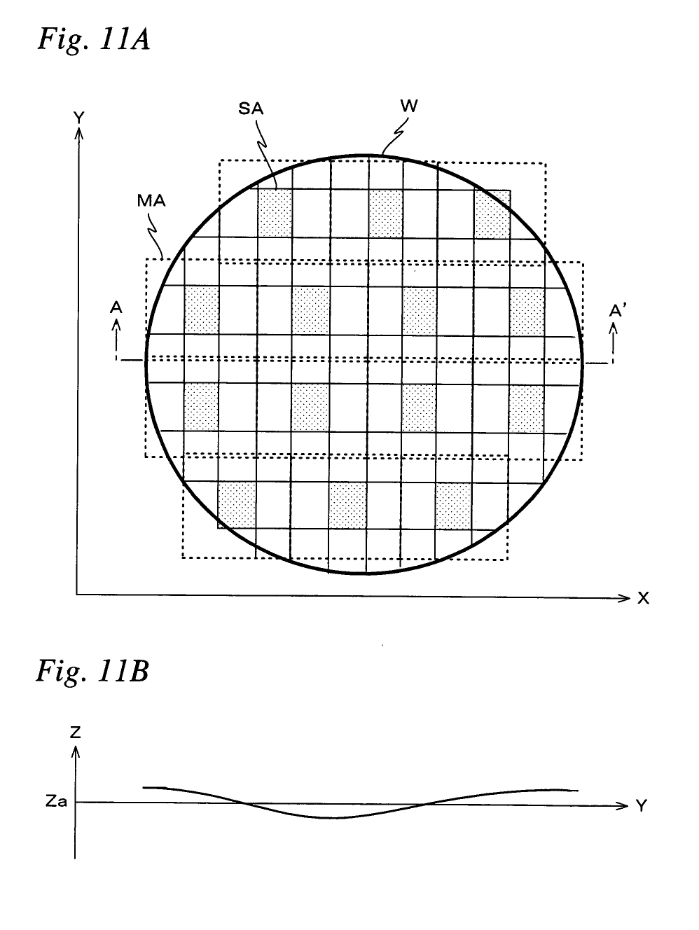

In the wafer alignment, among shot areas SA on wafer W represented by a solid line frame in FIG. 11A, 14 shot areas as shown stippled in the drawing are to be selected as sample shot areas. In this case, the wafer alignment marks arranged in the sample shot areas are detected by alignment system ALG, and position information of the marks within the XY plane is detected, and then an arrangement coordinate of shot areas on wafer W is computed from the detection results in step 217, which will be described later.

Incidentally, in the wafer alignment, wafer stage WST is moved in the XY plane and the wafer alignment mark arranged in each sample shot area is sequentially moved into the detection field of alignment system ALG, and then the wafer alignment mark is detected. In other words, when the wafer alignment marks arranged in all sample shot areas are detected, the detection field of alignment system ALG sequentially moves to 14 sample shot areas in a predetermined route. In FIG. 11A, measurement area MA of the multipoint AF system when the detection field of alignment system ALG catches the center of each sample shot area is shown by a dotted line frame. The detection field of alignment system ALG sequentially moves to 14 sample shots in a predetermined route in this manner, which enables measurement area MA of the multipoint AF system (60A, 60B) to cover the substantially entire surface of wafer W.

Then, in step 215, the wafer alignment marks arranged in the sample shot areas are detected by alignment system ALG, and also the Z position of the surface (the surface position) of wafer W is measured by the multipoint AF system (60A, 60B). That is, every time when the detection field of alignment system ALG moves to in the vicinity of each sample shot, the Z positions at measurement points S₁₁ to S₈₈ within the measurement area of the multipoint AM system, as is shown by the dotted line frame in FIG. 11A, are measured. With this measurement, the Z position of the substantially entire area of the surface subject to exposure of wafer W can be obtained. Further, when measuring the Z positions at measurement points S₁₁ to S₈₈ of the multipoint AF system (60A, 60B), the position in the XY plane and the Z position of wafer stage WST at this point of time are also obtained by measurement of wafer interferometer 18. The difference between the Z-positions at the measurement points at this point of time and the best focus position at origin P₂₄ of projection optical system PL is ΔZ shown in FIG. 8A.

Incidentally, the detection origins of measurement points S₁₁ to S₈₈ of the multipoint AF system (60A, 60B) have the deviation as is described earlier, and therefore offset components D₁₁ to D₈₈ obtained in the above step 205 need to be canceled from the measurement value of the Z position at each measurement point.

As is described above, in the wafer alignment in step 215, the Z position of the surface subject to exposure of wafer W is measured by the multipoint AF system (60A, 60B) together with measurement of the wafer alignment marks. From this Z position and the measurement value of wafer interferometer 18 at the time of measuring the Z-position (position information within the XY plane of wafer stage WST and position information in the Z-axis direction), information related to a surface shape of the surface subject to exposure of wafer W can be obtained. In the following description, the information is called as a Z map, and a processing for obtaining the Z map is called as a Z mapping. Incidentally, because the Z map is data that is discrete with regard to the XY plane, a continuous function that shows information related to a surface shape of the surface subject to exposure of wafer W may be made by a predetermined interpolation computation, a statistical computation or the like. FIG. 11B shows an example of the continuous value function that is made based on the Z map of the cross section taken along the line A-A′ in FIG. 11A. ‘Za’ in the drawing represents the average Z position of the surface subject to exposure of wafer W in the Z map.

In the next step, step 217, an arrangement coordinate of shot areas on wafer W is computed based on the results of the wafer alignment by the EGA method detected in the above step 215. Then, in the next step, step 219, a position order profile in six degrees of freedom of the XYZ coordinate system of wafer stage WST during scanning exposure is made based on the arrangement coordinate, the Z map and the baseline measurement results in the above step 209. In this case, when making the position order profile that contributes to the autofocus leveling control based on the Z map made in the above step 215, it is a matter of course that deviation ΔZ between the Z axis and the Z′ axis as shown in FIG. 8A needs to be considered.

In the next step, step 221, scanning exposure is performed to a plurality of shot areas on wafer W. Specifically, wafer W (wafer stage WST) is moved to an acceleration starting position for exposure of a first shot area (a first shot) based on the position order profile in six degrees of freedom of the XYZ coordinate system of wafer stage WST that is made in the above step 219, and at the same time, reticle R (reticle stage RST) is moved to an acceleration starting position. Then, liquid supply/drainage system 132 starts supply/drainage of water Lq to the space between tip lens 91 and wafer W. Then, based on the position order profile made in the above step 219, relative scanning (synchronous movement) of wafer W (wafer stage WST) and reticle R (reticle stage RST) in the Y-axis direction is started, and the scanning exposure is performed to the first shot on wafer W. By this operation, a circuit pattern of reticle R is sequentially transferred to the first shot on wafer W via projection optical system PL.

During the scanning exposure described above, in order to make exposure area IA on a surface of wafer W substantially conform to the best image-forming plane of projection optical system PL (be positioned within the range of depth of focus of the image-forming plane), by driving wafer stage WST in the Z-axis direction, the θx direction, and the θz direction via wafer stage drive section WSC based on the XY plane position and the Z position of wafer stage WST that are measured by wafer interferometer 18 and the Z map detected in step 215, the open-loop focus leveling control to wafer W is achieved.

Then, when the scanning exposure operations to the first shot are completed, main controller 20 moves wafer stage WST so that wafer W is positioned at an acceleration starting position for exposure to a second shot area (a second shot) on wafer W. In this case, since a complete alternate scanning method is employed, reticle stage RST moves to an acceleration starting position for performing exposure to the next shot area at the time when a series of operations for scanning exposure to the previous shot area is completed.

Main controller 20 then starts the relative scanning of reticle stage RST and wafer stage WST and performs the scanning exposure in the same manner as described earlier to sequentially transfer a pattern of reticle R to the second shot on wafer W via projection optical system PL, and during the transferring, the same open-loop focus leveling control is executed to wafer W as is described earlier.

Afterward, the movement of wafer stage WST (a stepping operation between shots) and the scanning exposure in the same manner as described above are repeatedly performed, and a pattern of reticle R is transferred to the third and succeeding shot areas on wafer W.

After the scanning exposure to all shot areas on wafer W is completed in this manner, the supply/drainage of water Lq by liquid supply/drainage system 132 is stopped, and in step 223, wafer stage WST is moved to an unloading position and wafer W is unloaded by a wafer unloader (not shown). After step 223 ends, the processing is completed.

Incidentally, in the embodiment, after the best focus position of projection optical system PL is detected, the offset component of the multipoint AF system (60A, 60B) is detected, however, the order may be reversed. Further, the search alignment does not have to be performed. In addition, the number of sample shots in the fine alignment is not limited to 14, and for example, may be 8. In that case, the surface position detection of wafer W is to be performed in area MA as is shown in FIG. 11A regardless of detection of the alignment marks by alignment system ALG.

Further, in the case wafer W is a bare wafer, the search alignment in step 213 and the fine alignment in step 215 (and further, the arrangement coordinate computation in step 217) are not performed, however, the surface position detection of wafer W needs to be performed by the multipoint AF system.

As is obvious from the description so far, in exposure apparatus 100 of the embodiment, at least a part of a stage is composed of wafer stage WST and at least a part of a first position detection unit and a second position detection unit is composed of wafer interferometer 18. A surface shape detection system is composed including apart of the multipoint AF system (60A, 60B) and main controller 20, and an adjustment unit is composed including a part of main controller 20. In addition, a measurement unit is composed including a part of main controller 20. Further, a focal point position detection system is composed including the multipoint AF system (60A, 60B). Further, a detection mechanism is composed including the RA detection system (12A, 12B).

In other words, a part of the function of the surface shape detection system is achieved by the processing in step 215 (FIG. 9), the function of the adjustment unit is achieved by the processing in steps 205 and 221 (FIG. 9) and the like, and the function of the measurement unit is achieved by the processing in subroutine 201 (FIGS. 9 and 10), which are performed by the CPU of main controller 20. Further, in the embodiment, the function of main controller 20 is achieved by one CPU, however, this function may be achieved by a plurality of CPUs.

As is described in detail above, in exposure apparatus 100 of the embodiment, the information (Z map) related to a surface shape of the surface subject to exposure of wafer W held by wafer stage WST is detected by the surface shape detection system (the multipoint AF system (60A, 60B), a part of main controller 20) prior to projection exposure, and when the projection exposure is performed, a surface position of wafer W on wafer stage WST is adjusted by main controller 20 based on the information (the Z map) related to the surface shape of the surface subject to exposure detected by the surface shape detection system. Therefore, when performing the projection exposure, exposure area IA on wafer W during scanning exposure can be positioned within a range of depth of focus of the best image-forming plane of projection optical system PL, without detecting in real time the position of wafer W in a direction of optical axis AX of projection optical system PL, which makes it possible to achieve exposure with high precision by the projection optical system having large numerical aperture.

Further, in the embodiment, main controller 20 detects the best image-forming plane by measuring the best focus position of projection optical system PL and adjusts a surface position of the surface subject to exposure of wafer W using the best image-forming plane as a datum. However, the best image-forming plane of projection optical system PL does not need to be obtained when it is ensured that the best image-forming plane of projection optical system PL is substantially parallel to the XY plane, and the best focus position at any one measurement point (for example, on the optical axis) within the effective exposure field only has to be obtained. In addition, the distance between measurement points P₁₁ to P₃₇ and the number of the measurement points are not limited to those in the embodiment described above.

Further, in the embodiment, the best focus position of projection optical system PL is obtained by the aerial image measurement of aerial image measurement unit 59. However, the present invention is not limited to this, and the detection method of the best focus position may be any method. For example, a predetermined pattern is actually exposed on wafer W at a plurality of Z positions, and the Z position where the exposure result is best may be determined as the best focus position. In this case, the exposure apparatus does not need to be equipped with the aerial image measurement unit.

Further, in the embodiment described above, the center of measurement area MA of the multipoint AF system (60A, 60B) is made coincident with the center of the detection field of alignment system ALG, however, it is not always necessary to do so. In the case detection of the wafer alignment mark by alignment system ALG and detection of a surface position of wafer W by the multipoint AF system (60A, 60B) are not simultaneously performed, alignment system ALG and the multipoint AF system may be arranged separately. However, when alignment system ALG and the multipoint AF system are arranged as in the embodiment above, the detection of the wafer alignment mark and the detection of a surface position of wafer W can be performed at the same time, which is advantageous in regard to throughput.

Further, in the embodiment described above, the number of measurement points of the multipoint AF system (60A, 60B) is 8×8=64 points, however, it is a matter of course that the number is not limited to 64. In addition, a size of measurement area MA, a size and a direction of each measurement point are not limited to those in the embodiment above. For example, the distance between the measurement points may be the same as the distance between the measurement points (X: 4 mm, Y: 3.5 mm) at which the best focus position of projection optical system PL is measured. In addition, in the embodiment above, a detection system that detects a surface position of wafer W is the multipoint AF system (60A, 60B), however, the detection system does not need to be the multipoint AF system. For example, the detection system may be a detection system that detects the Z position at only one point of wafer W. In this case, since an offset component of the detection system cannot be considered, the offset component does not need to be detected as in the above step 205, and ΔZ as shown in FIG. 8A only has to be detected.

Further, in the embodiment described above, when detecting the information (the Z map) related to a surface shape of the surface subject to exposure of wafer W using the multipoint AF system (60A, 60B), the Z position of wafer stage WST at the time of the detection is measured by wafer interferometer 18, and based on the measurement results, the surface of wafer W which shape is detected is made to conform to the best image-forming plane of projection optical system PL within a range of depth of focus. In this manner, as exposure apparatus 100 shown in FIG. 1, when the exposure apparatus is equipped with a Z interferometer that covers a wide area parallel to the XY plane from below projection optical system PL and to below alignment system ALG, the Z position of wafer stage WST can be constantly detected by the same wafer interferometer 18 regardless of the position of wafer stage WST and the Z position can be used as the absolute Z position.

However, the configuration of an exposure apparatus is not limited to the one in the embodiment above. For example, in an exposure apparatus that is not equipped with wafer interferometer 18 as shown in FIG. 1, and for example, in an exposure apparatus an interferometer that measures the Z position of wafer stage WST located below projection optical system PL and an interferometer that measures the Z position of wafer stage WST located below alignment system ALG are independent of each other, or in an exposure apparatus that is not equipped with an interferometer for measuring the Z position, the Z position at the time of detecting a surface shape of the surface subject to exposure of wafer W located at the alignment position cannot be referred to when performing exposure.

In such a case, the Z position may be aligned using the RA detection systems (12A, 12B). In the following description, the alignment method will be described.

For example, when performing the Z mapping in the above step 215, along with a surface shape of the surface subject to exposure of wafer W, a surface position of fiducial mark plate FM is also measured using the multipoint AF system (60A, 60B), and stored in the internal memory. Then, in the case wafer stage WST is moved to below projection optical system PL in order to perform exposure to wafer W on wafer stage WST, first fiducial mark WM₁ and WM₂ on fiducial mark plate FM are detected by the RA detection system (12A, 12B). Main controller 20 drives wafer stage WST in the Z-axis direction, and finds the Z position where the contrast of light intensity signals by the RA detection system (12A, 12B) corresponding to the first fiducial marks reaches the peak. On the assumption that the focusing operations in the above step 327 have been already performed in the RA detection system (12A, 12B) at this point of time and a surface position of fiducial mark plate FM is set so as to conform to the best image-forming plane of projection optical system PL, this position is to correspond to the best focus position of the projection optical system. Accordingly, in this manner, the Z position of the surface subject to exposure of wafer W at present can be grasped from a relative positional relation between the surface position of fiducial mark plate FM and the surface position of the surface subject to exposure of wafer W. Therefore, as in the embodiment above, the surface subject to exposure of wafer W can be made to conform to the best image-forming plane of projection optical system PL within a range of depth of focus, during scanning exposure.

Incidentally, the best image-forming plane of projection optical system PL (the best focus position) does not necessarily have to be made to conform to the best focus position of the RA detection system (12A, 12B) or the like. The deviation between them in the Z-axis direction only has to be known. This is because when fiducial mark plate FM can be positioned at the best focus position of the RA detection system (12A, 12B) by detecting fiducial mark plate FM by the RA detection system (12A, 12B), the relative positional relation between the fiducial mark plate FM and the best image-forming plane of projection optical system PL at this point of time can be determined, and therefore the best image-forming plane of projection optical system PL can be made to conform to the surface subject to exposure of wafer W within a range of depth of focus. Thus, the RA detection system does not necessarily have to be equipped with the focusing unit as in the embodiment.

However, in this case, calibration of the positional relation between the best image-forming plane of projection optical system PL and the best focus position of the RA detection system needs to be performed in advance. The best image-forming plane of projection optical system PL can be obtained in the same method as in the embodiment described above. Meanwhile, the best focus position of the RA detection system can also be obtained from the contrast curve in the Z-axis direction of the detection results of the first fiducial marks on fiducial mark plate FM, and the like.

As is described above, when detecting a surface shape of the surface subject to exposure of wafer W, an absolute Z position of a surface of wafer W only has to be obtained. However, the exposure surface of wafer W can be made to conform to the best image-forming plane of projection optical system PL by only obtaining a relative Z position of the surface of wafer W with respect to a datum plane on wafer stage WST.

Incidentally, the RA detection system does not necessarily have to be used in detection of the Z position of fiducial mark plate FM. The point is that a relation between the surface of fiducial mark plate FM and the best image-forming plane of projection optical system PL only has to be obtained and another detection system that can detect the surface position of fiducial mark plate FM via projection optical system PL may be used, or the surface position of fiducial mark plate FM may be detected using a non-optical detection system such as a capacitance sensor without water. Further, another datum plane may be arranged on wafer stage WST and used, without using fiducial mark plate FM.

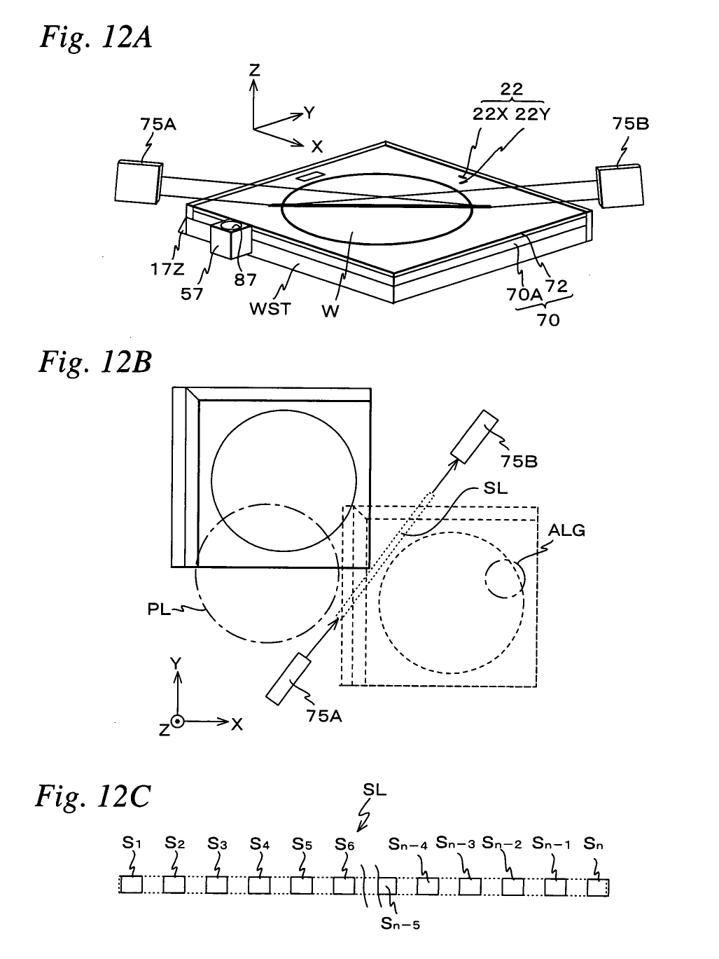

Further, in the embodiment described above, information related to the surface shape of the surface subject to exposure of wafer W is detected using the multipoint AF system (60A, 60B) that has a similar configuration to a multipoint AF system disclosed in Kokai (Japanese Unexamined Patent Application Publication) No. 06-283403 and has a measurement area whose center coincides with the center of the detection field of alignment system ALG, however, the present invention is not limited to this. For example, a surface shape detection unit as shown in FIGS. 12A and 12B may be used. As is shown in FIG. 12A, the surface shape detection unit is composed including an irradiation system 75A that makes a line-shaped beam having a length longer than at least a diameter of wafer W enter from an oblique direction to wafer W on wafer stage WST and an photodetection system 75B such as a one-dimensional CCD sensor that receives a reflected beam of the beam irradiated by irradiation system 75A. As is shown in FIG. 12B, irradiation system 75A and photodetection system 75B are arranged so that a line-shaped irradiation area SL is located between projection optical system PL and alignment system ALG.

In actual, the line-shaped beam irradiated from irradiation system 75A is formed by a plurality of point-like (or slit-like) laser beams that are parallel to each other and are arranged in one direction, and irradiation area SL actually is, as is shown in FIG. 12C, a set of irradiation areas S₁to Sₙ of a plurality of point-like beams. Accordingly, in the same principle as the detection principle for detecting the Z position at each measurement point of the multipoint AF system (60A, 60B) in the embodiment above, when irradiation areas S₁ to Sₙ are used as measurement points S₁ to Sₙ and the position deviation amount of the photodetection position of the reflected beam in photodetection system 75B from a datum position is measured, the Z position of wafer W at each of measurement points S₁ to Sₙ can be detected.

The measurement results of photodetection system 75B are sent to main controller 20. Main controller 20 detects information related to a surface shape of the surface subject to exposure of wafer W based on the measurement results, that is, the position deviation amount of the photodetection position of the reflected beam in photodetection system 75B from the datum position.

Irradiation area SL is arranged so as to make column of measurement points S₁ to Sₙ intersect with the X-axis and the Y-axis as is shown in FIG. 12B,so that wafer W on wafer stage WST passes irradiation area SL when wafer stage WST is moved from below alignment system ALG (the position shown by dotted lines) to below projection optical system PL (the position shown by solid lines), for example, in order to perform exposure after measurement of the wafer alignment mark by alignment system ALG is completed. With this arrangement, wafer W is relatively scanned with respect to irradiation area SL while wafer stage WST is being moved between the alignment and the exposure. Therefore, by detecting the measurement results at measurement points S₁ to Sₙ at predetermined sampling intervals during the relative scanning (while wafer W is passing irradiation SL), a surface shape of the entire surface subject to exposure of wafer W can be detected using the detection results. By detecting a surface shape of wafer W while moving wafer stage WST from an alignment position (a measurement position where the alignment mark on wafer W is detected by alignment system ALG) to an exposure position (an exposure position where exposure to wafer (substrate) W is performed using projection optical system PL) as is described above, the surface shape of the surface subject to exposure of wafer W can be detected without decreasing the throughput. As a matter of course, the surface shape of the surface subject to exposure of wafer W may be detected not only while moving wafer stage WST from the alignment position to the exposure position, but also, for example, while moving wafer stage WST from a wafer loading position where wafer W to be exposed next is loaded onto wafer stage WST to the alignment position, that is, before the alignment mark on wafer W is detected by alignment system ALG.

Incidentally, the arrangement of measurement points S₁ to Sₙ is not limited to the above example, and the measurement points may be arranged parallel to the X axis or the Y axis. Further, the measurement of the surface shape of wafer W using measurement points S₁ to Sₙ is not necessarily performed between the measurement operations of the wafer alignment mark and the wafer exposure operations, and for example, may be performed before the measurement of the wafer alignment mark. The point is that wafer W has to be relatively scanned with respect to irradiation area SL before exposure of wafer W.

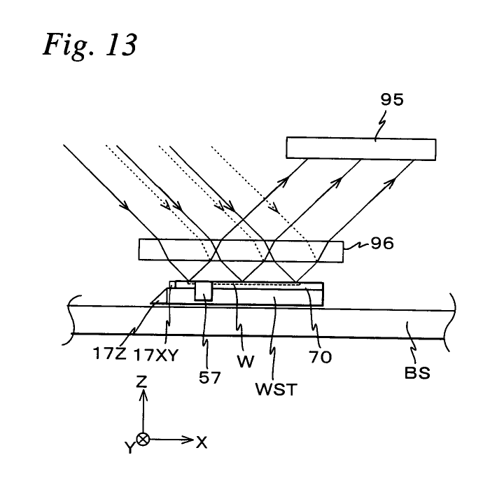

Alternatively, the exposure apparatus may be equipped with a surface shape detection unit having a configuration as is shown in FIG. 13. The surface shape detection unit shown in FIG. 13 is composed including a light source (not shown) that emits an illumination light to be incident from an oblique direction, a parallel plate 96 that has a translucent reference plane inserted between the light source and wafer W on wafer stage WST, and a photodetection unit 95. The area of parallel plate 96 that the beams of the illumination light irradiated from the light source enter is set to be sufficiently larger than at least the diameter of wafer W. As is shown in FIG. 13, a part of the incident beams shown by solid lines passes through parallel plate 96 to reach the surface subject to exposure of wafer W, and is reflected off the surface to enter parallel plate 96 again. The reflected beams that enter again parallel plate 96 overlap the incident beams shown by dotted lines that are reflected off the translucent reference plane at the incident position, and their interference fringe is formed in photodetection unit 95 such as a two-dimensional CCD camera. Accordingly, from the detection results of the interference fringe, the surface shape of the surface subject to exposure of wafer W can be detected. In the normal Fizeau interferometer, an incident angle of the incident lightwave with respect to a reflection object to be detected is set to be perpendicular, however, in the surface shape detection unit using the interferometer as shown in FIG. 13, the incident lightwave is set to enter the surface subject to exposure of wafer W from an oblique direction. With this setting, the influence by a circuit pattern formed on wafer W and the like can be reduced, and also the fringe sensitivity can be improved.

However, the configuration of the interferometer for measuring a surface shape of the surface subject to exposure of wafer W is not limited to the one as shown in FIG. 13. A Fizeau interferometer and a Twyman-Green interferometer in which the incident lightwave as described above enters perpendicularly to the surface to be detected may be used. In addition, an oblique incident type interferometer as disclosed in Kokai (Japanese Unexamined Patent Application Publication) Nos. 04-221704 and 2001-004336 may be used.

Incidentally, the arrangement of the surface shape detection unit as is shown in FIG. 13 is free, and for example, the surface shape detection unit may be arranged in the vicinity of a loading position of the wafer, or may be arranged similar to the surface shape detection unit shown in FIG. 12B.

Further, in the embodiment above, the movable mirror for Z position measurement arranged on wafer stage WST is only movable mirror 17Z arranged in the −X end. However, the movable mirror is not limited to this, and a movable mirror similar to movable mirror 17Z is also arranged in the +X end of wafer stage WST to irradiate the measurement beam also from the X side, and the Z position of wafer stage WST maybe obtained from the measurement results of the Z positions on both sides (for example, the average of the results). In this manner, the Z position of wafer stage WST can be measured with good accuracy regardless of the rolling of wafer stage WST.

Further, the movable mirror in the Z-axis direction is not limited to movable mirror 17Z as shown in the drawings such as FIG. 1. For example, a prism that makes the measurement beam parallel to the X axis be reflected so as to be a beam parallel to the Z axis without fail may be used as a movable mirror for Z position measurement.

In addition, in the embodiment above, wafer interferometer 18 that can measure the position within the XY plane and the Z position of wafer stage WST is used, however, it is a matter of course that an interferometer that can measure the position within the XY plane and an interferometer that can measure the Z position are separately arranged.

In addition, the movable mirror for Z position measurement does not have to be arranged on a side surface of wafer stage WST and may be integrated with the movable mirror for XY position measurement. Alternatively, a movable mirror is arranged on a bottom surface of wafer stage WST and the Z position of wafer stage WST maybe measured by irradiating the measurement beam from the −Z side of wafer stage WST.

Incidentally, in the embodiment above, ultra pure water (water) is used as the liquid, however, as a matter of course, the present invention is not limited to this. As the liquid, a liquid that is chemically stable, having high transmittance to illumination light IL and safe to use, such as a fluorine-containing inert liquid may be used. As such a fluorine-containing inert liquid, for example, Fluorinert (the brand name of 3M United States) can be used. The fluorine-containing inert liquid is also excellent from the point of cooling effect. Further, as the liquid, a liquid which has high transmittance to illumination light IL and a refractive index as high as possible, and furthermore, a liquid which is stable against the projection optical system and the photoresist coated on the surface of the wafer (for example, cedarwood oil or the like) can also be used. Further, in the case the F₂ laser is used as the light source, fomblin oil may be selected.

Further, in the embodiment above, the liquid that was recovered may be reused, and in this case, it is preferable to arrange a filter for removing impurities from the recovered liquid in the liquid recovery unit, the recovery pipes, or the like.

Incidentally, in the embodiment above, the optical element of projection optical system PL closest to the image plane side is tip lens 91. The optical element, however, is not limited to the lens, and it may be an optical plate (such as a parallel plane plate) used for adjusting the optical properties of projection optical system PL, for example, aberration (such as spherical aberration or coma), or it may simply be a cover glass. The surface of the optical element of projection optical system PL closest to the image plane side (tip lens 91 in the embodiment above) may be contaminated by coming into contact with the liquid (water, in the embodiment above) due to scattered particles generated from the resist by the irradiation of illumination light IL or adherence of impurities in the liquid. Therefore, the optical element is to be fixed freely detachable (exchangeable) in the lowest section of barrel 40, and may be exchanged periodically.

In such a case, when the optical element that comes into contact with the liquid is the lens, the cost for replacement parts is high, and the time required for exchange becomes long, which leads to an increase in the maintenance cost (running cost) as well as a decrease in throughput. Therefore, the optical element that comes into contact with the liquid may be, for example, a parallel plane plate, which is less costly than tip lens 91.

Further, in the embodiment above, the range of the liquid (water) flow only has to be set so that it covers the entire projection area (the irradiation area of illumination light IL) of the pattern image of the reticle. Therefore, the size may be of any size, however, on controlling the flow speed, the flow amount and the like, it is preferable to keep the range slightly larger than the irradiation area but as small as possible.

Incidentally, the projection optical system made up of a plurality of lenses and projection unit PU are incorporated into the main body of the exposure apparatus, and furthermore liquid supply/drainage unit 132 is attached to projection unit PU. Then, along with the optical adjustment operation, the reticle stage and the wafer stage that are made up of multiple mechanical parts are also attached to the main body of the exposure apparatus and the wiring and piping are connected. And then, total adjustment (such as electrical adjustment and operation check) is performed, which completes the making of the exposure apparatus of the embodiment above. The exposure apparatus is preferably built in a clean room where conditions such as the temperature and the degree of cleanliness are controlled.

Further, in the embodiment above, the case has been described where the present invention is applied to a scanning exposure apparatus by the step-and-scan method or the like, however, it is a matter of course that the present invention is not limited to this. In other words, the present invention can also be suitably applied to a reduction projection exposure apparatus by the step-and-repeat method. Further, the present invention can also be suitably applied to exposure in a reduction projection exposure apparatus by the step-and-stitch method in which shot areas are synthesized. Further, the present invention can also be applied to a twin-stage type exposure apparatus that is equipped with two wafer stages. Furthermore, it is a matter of course that the present invention can also be applied to an exposure apparatus that does not use the immersion method.

The usage of the exposure apparatus is not limited to the exposure apparatus used for manufacturing semiconductor devices. The present invention can be widely applied to, for example, an exposure apparatus for manufacturing liquid crystal displays which transfers a liquid crystal display deice pattern onto a square shaped glass plate, and to an exposure apparatus for manufacturing organic EL, thin-film magnetic heads, imaging devices (such as CCDs), micromachines, DNA chips or the like. Further, the present invention can also be applied to an exposure apparatus that transfers a circuit pattern onto a glass substrate or a silicon wafer not only when producing microdevices such as semiconductors, but also when producing a reticle or a mask used in an exposure apparatus such as an optical exposure apparatus, an EUV exposure apparatus, an X-ray exposure apparatus, or an electron beam exposure apparatus.

Further, the light source of the exposure apparatus in the embodiment above is not limited to the ArF excimer laser light source, and a pulsed laser light source such as a KrF excimer laser light source or an F₂ laser light source, or an ultra high-pressure mercury lamp that generates a bright line such as the g-line (wavelength 436 nm) or the i-line (wavelength 365 nm) can also be used. Further, a harmonic wave may also be used that is obtained by amplifying a single-wavelength laser beam in the infrared or visible range emitted by a DFB semiconductor laser or fiber laser, with a fiber amplifier doped with, for example, erbium (or both erbium and ytteribium), and by converting the wavelength into ultraviolet light using a nonlinear optical crystal. Further, the magnification of the projection optical system is not limited to a reduction system, and the system may be either an equal magnifying system or a magnifying system.

Further, in the embodiment above, illumination light IL of the exposure apparatus is not limited the light having the wavelength equal to or greater than 100 nm, and it is needless to say that the light having the wavelength less than 100 nm may be used. For example, in recent years, in order to expose a pattern equal to or less than 70 nm, an EUV exposure apparatus that makes an SOR or a plasma laser as a light source generate an EUV (Extreme Ultraviolet) light in a soft X-ray range (such as a wavelength range from 5 to 15 nm), and uses a total reflection reduction optical system designed under the exposure wavelength (such as 13.5 nm) and the reflective type mask has been developed. In the EUV exposure apparatus, the arrangement in which scanning exposure is performed by synchronously scanning a mask and a wafer using a circular arc illumination can be considered.

Further, the present invention can be applied to an exposure apparatus that uses charged particle beams such as an electron beam or an ion beam. Incidentally, an electron beam exposure apparatus may employ any of the pencil beam method, variable beam shaping method, self projection method, blanking aperture array method, and mask projection method. For example, in an exposure apparatus that uses an electron beam, an optical system equipped with an electromagnetic lens constitutes an exposure optical system and an exposure optical system unit is configured including a barrel of the exposure optical system and the like.

[Device Manufacturing Method]

Next, an embodiment will be described of a device manufacturing method that uses exposure apparatus 100 described above in the lithography process.

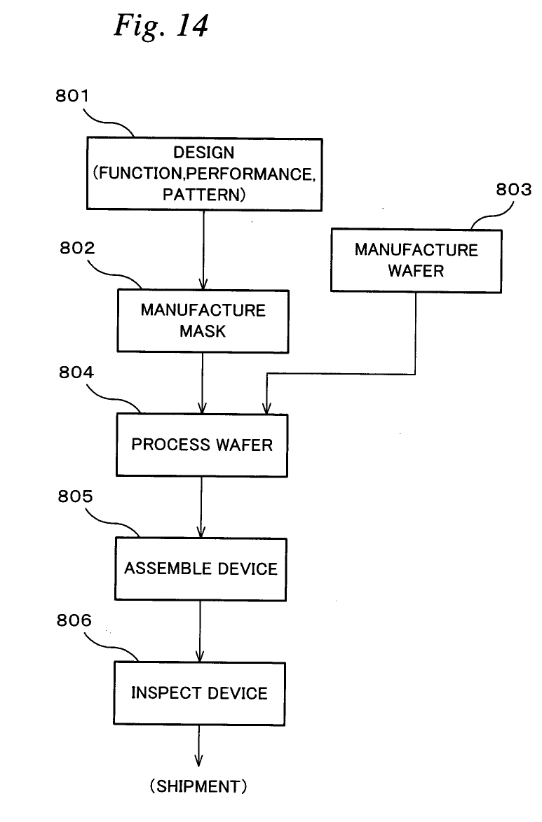

FIG. 14 shows the flowchart of an example when manufacturing a device (a semiconductor chip such as an IC or an LSI, a liquid crystal panel, a CCD, a thin-film magnetic head, a micromachine, and the like). As shown in FIG. 14, in step 801 (design step), function and performance design of device (such as circuit design of semiconductor device) is performed first, and pattern design to realize the function is performed. Then, in step 802 (mask manufacturing step), a mask on which the designed circuit pattern is formed is manufactured. Meanwhile, in step 803 (wafer manufacturing step), a wafer is manufactured using materials such as silicon.

Next, in step 804 (wafer processing step), the actual circuit and the like are formed on the wafer by lithography or the like in a manner that will be described later, using the mask and the wafer prepared in steps 801 to 803. Then, in step 805 (device assembly step), device assembly is performed using the wafer processed in step 804. Step 805 includes processes such as the dicing process, the bonding process, and the packaging process (chip encapsulation), when necessary.

Finally, in step 806 (inspection step), tests on operation, durability, and the like are performed on the devices made in step 805. After these steps, the devices are completed and shipped out.

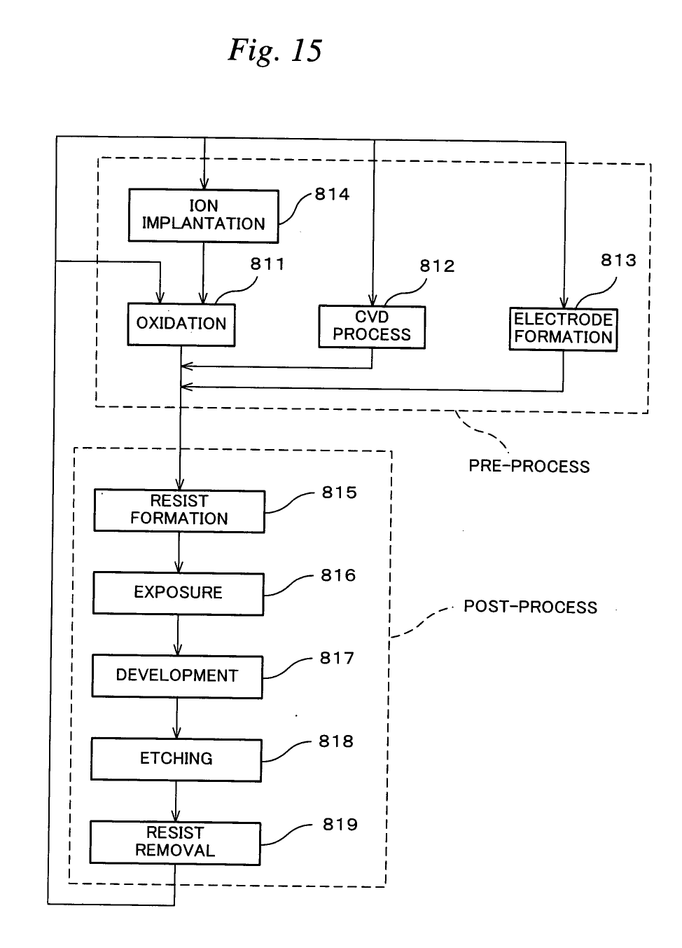

FIG. 15 is a flowchart showing a detailed example of step 804 described above, related to semiconductor device. Referring to FIG. 15, in step 811 (oxidation step), the surface of wafer is oxidized. In step 812 (CDV step), an insulating film is formed on the wafer surface. In step 813 (electrode formation step), an electrode is formed on the wafer by deposition. In step 814 (ion implantation step), ions are implanted into the wafer. Each of the above steps 811 to 814 constitutes the pre-process in each stage of wafer processing, and the necessary processing is chosen and is executed at each stage.

When the above-described pre-process ends in each stage of wafer processing, post-process is executed as follows. In the post-process, first in step 815 (resist formation step), a photosensitive agent is coated on the wafer as is described in the embodiment above. Then, in step 816 (exposure step), the circuit pattern of the mask is transferred onto the wafer using exposure apparatus 100 in the embodiment described above. Next, in step 817 (development step), the exposed wafer is developed, and in step 818 (etching step), an exposed member of an area other than the area where resist remains is removed by etching. Then, in step 819 (resist removing step), when etching is completed, the resist that is no longer necessary is removed.

By repeatedly performing the pre-process and the post-process, circuit patterns are hierarchically formed on the wafer.

When the above device manufacturing method of the embodiment described above is used, because exposure apparatus 100 and the exposure method of the embodiment above are used in the exposure process (step 816), exposure with good precision can be achieved. As a consequence, the productivity (including the yield) of high integration devices can be improved.

### INDUSTRIAL APPLICABILITY

As is described above, the exposure apparatus and the exposure method of the present invention is suitable to a lithography process for manufacturing semiconductor devices, liquid crystal display devices, or the like, and the device manufacturing method of the present invention is suitable for producing microdevices. Further, the surface shape detection unit of the present invention is suitable for detecting a surface shape of a substrate to be exposed.

1. An exposure apparatus that performs exposure to an object via a projection optical system, the apparatus comprising:
a stage that is movable in at least directions of three degrees of freedom that include an optical axis direction of the projection optical system and two-dimensional directions within a plane orthogonal to the optical axis while holding the object, and can adjust a position of the object in the optical axis direction;
a first position detection unit that detects position information of the stage in the optical axis direction;
a second position detection unit that detects position information of the stage within the plane orthogonal to the optical axis;
a surface shape detection system that detects information related to a surface shape of a surface subject to exposure of the object held on the stage, prior to the exposure; and
an adjustment unit that adjusts a surface position of the surface subject to exposure of the object by driving the stage based on the detection results of the surface shape detection system and the detection results of the first and second position detection units, when performing exposure to the object.

2. The exposure apparatus of claim 1, further comprising:
a measurement unit that measures a best focus position of the projection optical system, wherein
the adjustment unit adjusts a surface position of the surface subject to exposure of the object, using the measurement results of the measurement unit as a datum.

3. The exposure apparatus of claim 2 wherein
the measurement unit has an aerial image measurement instrument that is arranged on the stage and measures an aerial image formed by the projection optical system via a predetermined measurement pattern that is arranged within the plane orthogonal to the optical axis of the projection optical system, measures a change of the aerial image in at least one point within an effective exposure field, with respect to a change of the position of the stage in the optical axis direction, and measures the best focus position of the projection optical system based on the measurement results.

4. The exposure apparatus of claim 1, further comprising:
an off-axis alignment system that is used to detect an alignment mark formed on the object, wherein
the surface shape detection system has a focal point position detection system that detects a position of the surface subject to exposure of the object in the optical axis direction when the alignment mark is detected by the alignment system, and detects the information related to the surface shape of the surface subject to exposure of the object based on the detection results of the focal point position detection system and on the detection results of the second position detection unit when the position of the surface subject to exposure of the object in the optical axis direction is detected by the focal point position detection system.

5. The exposure apparatus of claim 4 wherein
the focal point position detection system is a multiple focal point position detection system that can severally detect a position of the surface subject to exposure of the object in the optical axis direction at each of a plurality of measurement points on the object by irradiating a measurement light to the plurality of measurement points and detecting a reflected light reflected off the measurement points.

6. The exposure apparatus of claim 5 wherein
the surface shape detection system detects a detection origin deviation between the measurement points, and detects a surface shape of the surface subject to exposure of the object taking the detection results into consideration.

7. The exposure apparatus of claim 1 wherein
the surface shape detection system includes an irradiation system that irradiates an illumination light to a strip-shaped area that the object held on the stage crosses by movement of the stage and a photodetection system that receives a reflected light of the illumination light from the surface subject to exposure of the object when the object crosses the strip-shaped area, and detects the information related to the surface shape of the surface subject to exposure of the object based on a position deviation amount from a datum position of a photodetection position of the reflected light in the photodetection system.

8. The exposure apparatus of claim 1 wherein
the surface shape detection system has an interferometer, and detects the information related to the surface shape of the surface subject to exposure of the object using the interferometer.

9. The exposure apparatus of claim 8 wherein
the interferometer is an oblique incident interferometer whose lightwave enters the surface subject to exposure of the object from an oblique direction.

10. The exposure apparatus of claim 1 wherein
the adjustment unit takes into consideration the position information of the stage in the optical axis direction detected by the first position detection unit, when the information related to the surface shape of the surface subject to exposure of the object is detected by the surface shape detection system, and adjusts a surface position of the surface subject to exposure of the object, when performing exposure to the object.

11. The exposure apparatus of claim 1 wherein
the surface shape detection system detects information related to a relative position in the optical axis direction between the surface subject to exposure of the object and a datum plane of the stage, along with the information related to the surface shape of the surface subject to exposure.

12. The exposure apparatus of claim 11, further comprising:
a detection mechanism that can detects a position of the stage in the optical axis direction via the projection optical system, wherein
prior to the exposure, the adjustment unit specifies a surface position of the surface subject to exposure of the object in the optical axis direction, based on the detection results of the detection mechanism, the information related to the relative position and the information related to the surface shape of the surface subject to exposure of the object.

13. The exposure apparatus of claim 12 wherein
the adjustment unit detects a difference between a detection datum of the detection mechanism and the best focus position of the projection optical system, and adjust a surface position of the surface subject to exposure of the object taking the detection results into consideration.

14. The exposure apparatus of claim 1 wherein
detection of the information related to the surface position of the surface subject to exposure of the object is performed in a state where the space between the surface shape detection system and the object is not filled with a liquid, and
the exposure is performed in a state where the space between the projection optical system and the object is filled with a liquid.

15. A device manufacturing method that includes a lithography process in which a device pattern is transferred onto an object using the exposure apparatus according to claim 1.

16. An exposure method in which exposure is performed to an object via a projection optical system, the method comprising:
a detection process in which information related a datum position of the object in an optical axis direction of the projection optical system is detected, along with information related to a surface shape of a surface subject to exposure of the object in the optical axis direction, prior to exposure; and
an exposure process in which exposure is performed while adjusting a surface position of the surface subject to exposure of the object based on the detection results.

17. The exposure method of claim 16, further comprising:
a best focus measurement process in which a best focus position of the projection optical system is measured, prior to the exposure process, wherein
in the exposure process, a surface position of the surface subject to exposure of the object is adjusted using the best focus position of the projection optical system as a datum.

18. The exposure method of claim 16, further comprising:
a calibration process in which calibration of a detection system is performed prior to the detection process, the detection system detecting the information related to a datum position of the object in the optical axis direction of the projection optical system, along with the information related to the surface shape of the surface subject to exposure of the object in the optical axis direction.

19. The exposure method of claim 16 wherein
the detection process is performed during detection of an alignment mark formed on the object.

20. The exposure method of claim 16 wherein
in the detection process, as the information related to the datum position of the object in the optical axis direction, position information of a stage holding the object in the optical axis direction when the information related to the surface shape of the surface subject to exposure is detected.

21. The exposure method of claim 16 wherein
in the detection process, as the information related to the datum position of the object in the optical axis direction, information related to a relative position in the optical axis direction between a datum plane of the stage holding the object and the surface subject to exposure.

22. The exposure method of claim 21, further comprising:
a datum plane position detection process in which a position of a datum plane of the stage in the optical axis direction is detected via the projection optical system, prior to the exposure process, wherein
in the exposure process, a surface position of the surface subject to exposure of the object in the optical axis direction is specified, based on the detection results of the datum plane position detection process, the information related to the relative position and the information related to the surface shape of the surface subject to exposure of the object.

23. The exposure method of claim 22, further comprising:
a calibration information detection process in which a datum position of a surface position of the surface subject to exposure of the object and the best focus position of the projection optical system are detected as calibration information, prior to the datum plane position detection process, wherein
in the exposure process, a surface position of the surface subject to exposure of the object is adjusted taking the calibration information into consideration.

24. The exposure method of claim 16 wherein
in the exposure process, exposure is performed to the object in a state where the space between the projection optical system and the object is filled with a liquid.

25. A device manufacturing method that includes a lithography process in which a device pattern is transferred onto an object using the exposure method according to claim 16.

26. A surface shape detection unit, comprising:
a stage that can hold an object and is movable in a predetermined direction;
an irradiation system that irradiates an illumination light to a strip-shaped area that the object held on the stage crosses by movement of the stage;
a photodetection system that receives a reflected light of the illumination light from a surface subject to exposure of the object when the object crosses the strip-shaped area;
a detection unit that detects information related to a surface shape of the surface subject to exposure of the object, based on a position deviation amount from a datum position of a photodetection position of the reflected light in the photodetection system.

27. An exposure apparatus, comprising:
a stage that can hold an object subject to exposure and is movable in a predetermined direction;
a detection unit that has an irradiation system to irradiate an illumination light to a strip-shaped area that the object held on the stage crosses by movement of the stage and a photodetection system to receive a reflected light of the illumination light from a surface subject to exposure of the object when the object crosses the strip-shaped area, and detects information related to a surface shape of the surface subject to exposure of the object based on output of the photodetection system; and
a controller that controls the stage so that the object crosses the strip-shaped area, and performs surface position adjustment of the surface subject to exposure of the object based on information of a surface shape of a substantially entire area of the surface subject to exposure of the object, the information being obtained by the object crossing the strip-shaped area once.

28. The exposure apparatus of claim 27, further comprising:
an optical system that is used to irradiate an exposure light to the object; and
an immersion mechanism that fills the space between the object and the optical system with a liquid, wherein
the detection unit detects the information related to the surface shape of the surface subject to exposure of the object, before the immersion mechanism fills the space between the object and the optical system with a liquid.

29. The exposure apparatus of claim 28, further comprising:
an alignment system that detects an alignment mark on the object, wherein
the alignment system detects the alignment mark on the object before the immersion mechanism fills the space between the object and the optical system with a liquid.

30. The exposure apparatus of claim 29 wherein
the detection unit detects the information related to the surface shape of the surface subject to exposure of the object after the alignment system detects the alignment mark.

31. The exposure apparatus of claim 29 wherein
the detection unit detects the information related to the surface shape of the surface subject to exposure of the object before the alignment system detects the alignment mark.

32. A device manufacturing method that includes a lithography process in which a device pattern is formed on an object using the exposure apparatus according to claim 27.
